(19) United States
(12) Patent Application Publication
(10) Pub. No.: US 2026/0098951 A1
(43) Pub. Date: Apr. 9, 2026

(54) SELECTABLE DISPLAY MODES FOR LIVE SONAR

(71) Applicant: Navico, Inc., Tulsa, OK (US)

(72) Inventors: Jeremiah D. Clark, Tulsa, OK (US); Jayme J. Caspall, Tulsa, OK (US)

(21) Appl. No.: 19/406,037

(22) Filed: Dec. 2, 2025

Related U.S. Application Data
(63) Continuation-in-part of application No. 19/175,074, filed on Apr. 10, 2025.
Application No. 19/175,074 is a continuation of application No. 18/140,990, filed on Apr. 28, 2023, now Pat. No. 12,306,353.

(51) Int. Cl. G01S 7/521; G01S 15/89

(52) U.S. Cl. CPC G01S 7/521; G01S 15/89

(57) ABSTRACT

A marine electronic device for a watercraft is configured to present live sonar imagery of an underwater environment. The device includes a display, a processor, a memory, and a communication interface for receiving sonar return data from a sonar transducer assembly comprising multiple sonar transducer arrays. The processor generates a first live sonar image based on first sonar return data representing a first volume of the underwater environment, wherein the entire portion of the first live sonar image is continually updated in real time. The device receives user input defining a portion of the first live sonar image corresponding to a second, smaller volume within the first volume, and generates a second live sonar image based on second sonar return data that is a subset of the first sonar return data. The second live sonar image is presented on the display to provide a focused view of the underwater environment.

### CROSS-REFERENCE TO RELATED APPLICATIONS

This application claims priority to and is a continuation-in-part of U.S. Patent Application No. 19/175,074, filed on April 10, 2025, and entitled “Beamforming Sonar Systems for 360 degree Live Sonar, and Associated Methods”, which claims priority to and is a continuation of U.S. Patent Application No. 18/140,990, filed on April 28, 2023, issued as U.S. Patent No. 12,306,353, and entitled “Beamforming Sonar Systems for 360 degree Live Sonar, and Associated Methods”; the contents of each being herein incorporated by reference in its entirety.

### FIELD

Example embodiments herein generally relate to sonar systems and, more particularly to, beamforming sonar systems that provide “live” sonar imagery.

### BACKGROUND

Sonar (SOund Navigation And Ranging) has been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater and provide an understanding of the underwater environment. Sonar transducer elements convert electrical energy into sound or vibrations. Sonar signals are transmitted into and through the water and reflected from encountered objects (e.g., fish, bottom surface, underwater structure, etc.). The transducer elements receive the reflected sound as sonar returns and convert the sound energy into electrical energy (e.g., sonar return data). Based on the known speed of sound, it is possible to determine the distance to and/or location of the waterborne or underwater objects. The sonar return data can also be processed to be displayed on a display device, giving the user a “picture” (or image) of the underwater environment.

Different types of sonar systems provide different sonar functionality, many with differing benefits. As such, there is need for sonar systems with improved sonar image functionality while still providing a reasonable cost to the user (e.g., an angler).

### BRIEF SUMMARY

Example embodiments provide sonar systems and marine electronic devices configured to present live sonar imagery of an underwater environment. Live sonar imagery refers to sonar images that are generated and updated in substantially real-time, providing users with immediate and continuous visual feedback of underwater conditions. This capability enables, for example, enhanced situational awareness, improved object detection, and more precise navigation or fishing operations.

Some example sonar systems include a sonar transducer assembly comprising multiple arrays of transducer elements. These transducer elements are configured to operate at a fixed phase shift and vary in frequency to beamform multiple sonar return beams. The beamformed sonar return beams may be filtered based on frequency to define angular coverage between a first range of angles and a second range of angles, with a gap formed between the two. By orienting multiple arrays in complementary directions, the system can achieve expanded sonar coverage, including full 180° or 360° imaging volumes beneath and/or around a watercraft.

The marine electronic device is configured to generate and present a live sonar image based on sonar return data received from the transducer assembly. The live sonar image may be formed as a plurality of image slices, each corresponding to a sonar return beam extending within a defined range of angles. The marine electronic device may associate each image slice with its angular origin and manage transitions between slices to produce a coherent and continuous sonar image.

To enhance usability, the marine electronic device includes a user interface that allows users to select among multiple display modes. A base display mode may define the overall perspective of the sonar image, such as a 360° view, a forward-facing view (e.g., 180°s in front of the watercraft), or a downward-facing view (e.g., 180° below the watercraft, such as from fore-to-aft or from port-to-starboard) – although other images/views are contemplated. In addition, users may select a focused display mode to view only a portion of the live sonar image, such as a zoomed-in portion, a directional portion (e.g., port-side or forward), or a dynamically tracked portion containing a target object.

The focused display mode may be generated by, for example, reprocessing a subset of the sonar return data corresponding to the selected angular region or by cropping or reframing the previously generated full sonar image to fit the display geometry, or other techniques and/or combinations thereof. These techniques allow the marine electronic device to present useful, expansive views while also enabling targeted focus on specific regions of interest, thereby improving the clarity and relevance of the sonar imagery presented to the user. This can be particularly useful on the watercraft where screen size devoted to the sonar imagery may be limited and/or at a premium.

In an embodiment, a marine electronic device of a watercraft is presented. The marine electronic device is configured to present sonar imagery and includes a display, a processor operably coupled to the display, a memory operably coupled to the processor, and a communication interface configured to receive sonar return data from a sonar transducer assembly comprising a plurality of sonar transducer arrays. The processor is configured to receive first sonar return data from the sonar transducer assembly. The first sonar return data corresponds to a first volume of an underwater environment. The processor is further configured to generate and present a live sonar image based on the first sonar return data. The live sonar image provides a representation of the first volume of the underwater environment and an entire portion of the live sonar image corresponding to the first volume is continually updated in real-time. The processor is configured to receive an indication of user input defining a portion of the live sonar image which corresponds to a second volume of the underwater environment that is within the first volume and less than the first volume. The processor is configured to generate and present, based on the portion of the live sonar image, a second live sonar image based on second sonar return data corresponding to the second volume of the underwater environment. The second sonar return data is a subset of data within the first sonar return data and is less than the first sonar return data.

In an embodiment a marine system for a watercraft is presented. The marine system includes a sonar transducer assembly comprising a plurality of sonar transducer arrays. Each sonar transducer array includes a plurality of transducer elements configured to operate at a fixed phase shift and vary in frequency so as to beamform multiple sonar return beams for receiving sonar return data from an underwater environment relative to the watercraft. The marine system further includes a marine electronic device. The marine electronic device includes a display, a processor operably coupled to the display, a memory operably coupled to the processor, and a communication interface configured to receive sonar return data from the sonar transducer assembly. The processor is configured to receive first sonar return data from the sonar transducer assembly; the first sonar return data corresponds to a first volume of the underwater environment. The processor is further configured to generate and present a live sonar image based on the first sonar return data; the live sonar image provides a representation of the first volume of the underwater environment; and an entire portion of the live sonar image corresponding to the first volume is continually updated in real-time. The processor is further configured to receive an indication of user input defining a portion of the live sonar image; the portion of the live sonar image corresponds to a second volume of the underwater environment that is within the first volume and less than the first volume. The processor is further configured to generate and present, based on the portion of the live sonar image, a second live sonar image based on second sonar return data corresponding to the second volume of the underwater environment; the second sonar return data is a subset of data within the first sonar return data and is less than the first sonar return data.

In an embodiment, a method for presenting sonar imagery on a display of a marine system of a watercraft is presented. The method includes receiving first sonar return data from a sonar transducer assembly comprising a plurality of sonar transducer arrays; each sonar transducer array includes a plurality of transducer elements configured to operate at a fixed phase shift and vary in frequency to beamform multiple sonar return beams. The method further includes generating and presenting a live sonar image based on the first sonar return data; the live sonar image provides a representation of a first volume of an underwater environment; and an entire portion of the live sonar image corresponding to the first volume is continually updated in real-time. The method further includes receiving an indication of user input defining a portion of the live sonar image; the portion corresponds to a second volume of the underwater environment that is within the first volume and less than the first volume. The method further includes generating and presenting a second live sonar image based on second sonar return data corresponding to the second volume of the underwater environment; the second sonar return data is a subset of the first sonar return data and is less than the first sonar return data.

In examples, the indication of user input includes a touch gesture received via a touchscreen of the display; the touch gesture defines the portion of the live sonar image to be presented in the second live sonar image.

In examples, the indication of user input includes a voice command received via a microphone; the voice command specifying a directional region of the underwater environment to be displayed in the second live sonar image.

In examples, the indication of user input includes a selection of a target object within the live sonar image, and wherein the processor is configured to dynamically update the second live sonar image over time such that the target object remains within the displayed portion of the underwater environment.

In examples, the indication of user input includes a selection of a predefined display mode; the predefined display mode corresponds to one of a forward-focused sector, a downward-focused sector, a port-side-focused sector, or a starboard-side-focused sector of the underwater environment.

In examples, the indication of user input includes a selection made via a remote device communicatively coupled to the marine electronic device; the remote device configured to transmit display mode instructions based on user interaction with a companion interface of the remote device.

In examples, the processor is further configured to present a first selectable interface element on the display; the first selectable interface element configured to allow a user to select a base display mode from among a plurality of base display modes.

In examples, the processor is further configured to present a second selectable interface element on the display; the second selectable interface element configured to allow the user to select a focused display mode amongst a plurality of predetermined focused display modes associated with the selected base display mode.

In examples, the processor is further configured to present a third selectable interface element on the user interface; the third selectable interface element configured to allow the user to return to the selected base display mode from a selected focused display mode.10.

In examples, the focused display modes include at least one of: a zoomed-in sector view, a port-side sector view, a starboard-side sector view, a forward-focused view, or a tracked-object view.

In examples, the second live sonar image is generated by reframing the live sonar image, such that only sonar image data corresponding to the portion of the live sonar image is presented.

In examples, the second live sonar image is generated by processing the subset of the data within the first sonar return data corresponding to the portion of the live sonar image.

In examples, the first live sonar image is a 360° image extending around and below the watercraft.

In examples, the first live sonar image is a 180° image extending below the watercraft in a fore-to-aft perspective.

In examples, the first live sonar image is a 180° image extending below the watercraft in a port-to-starboard perspective.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates an example watercraft including various sonar transducer assemblies, in accordance with some embodiments discussed herein;

FIG. 2A illustrates an example array of transducer elements, in accordance with some embodiments discussed herein;

FIG. 2B illustrates a side view of the array of transducer elements shown in FIG. 2A, wherein an example first range of angles and an example second range of angles for beamformed sonar return beams are illustrated, in accordance with some embodiments discussed herein;

FIG. 2C illustrates an end view of the array of transducer elements shown in FIG. 2B along with illustrated ranges of angles of beamformed sonar return beams, in accordance with some embodiments discussed herein;

FIG. 3 illustrates a zoomed-in perspective view of an example arrangement of eight arrays to provide 360° sonar coverage utilizing beamformed sonar return beams, in accordance with some embodiments discussed herein;

FIG. 4 illustrates a top view of example sonar beam coverage of the example arrangement of eight arrays shown in FIG. 3, in accordance with some embodiments discussed herein;

FIG. 5 illustrates a perspective view of the example sonar beam coverage of the example arrangement of eight arrays shown in FIG. 3-4, in accordance with some embodiments discussed herein;

FIG. 6A illustrates an example stacked arrangement of six arrays, in accordance with some embodiments discussed herein;

FIG. 6B illustrates an example stacked arrangement of eight arrays, in accordance with some embodiments discussed herein;

FIG. 6C illustrates an example stacked arrangement of twelve arrays, in accordance with some embodiments discussed herein;

FIG. 6D illustrates an example arrangement of eight arrays, in accordance with some embodiments discussed herein;

FIG. 6E illustrates an example arrangement of eight arrays, in accordance with some embodiments discussed herein;

FIG. 6F illustrates an example circular arrangement of one or more arrays, in accordance with some embodiments discussed herein;

FIG. 7A illustrates an example first layer of arrays along with their corresponding ranges of angles of beamformed sonar return beams, in accordance with some embodiments discussed herein;

FIG. 7B illustrates an example second layer of arrays along with their corresponding ranges of angles of beamformed sonar return beams, in accordance with some embodiments discussed herein;

FIG. 7C illustrates an example arrangement of the first layer of arrays shown in FIG. 7A and the second layer of arrays shown in FIG. 7B to provide continuous 360° sonar coverage from port-to-starboard of the watercraft, in accordance with some embodiments discussed herein;

FIG. 8 illustrates three example arrays arranged to provide continuous sonar coverage (e.g., of 180°) utilizing beamformed sonar return beams, in accordance with some embodiments discussed herein;

FIG. 9 shows a front view of an example transducer assembly that includes three arrays, in accordance with some embodiments discussed herein;

FIG. 10 illustrates a watercraft with an example transducer assembly utilizing three arrays to provide continuous sonar coverage from fore-to-aft of the watercraft in the downward direction over 180°, in accordance with some embodiments discussed herein;

FIG. 11 illustrates the watercraft with the example transducer assembly utilizing three arrays to provide continuous sonar coverage from port-to-starboard of the watercraft in the forward direction over 180°, in accordance with some embodiments discussed herein;

FIG. 12A shows an example marine electronic device presenting a 360° live sonar image about the watercraft, in accordance with some embodiments discussed herein;

FIG. 12B shows the example marine electronic device presenting a partial focused 360° live sonar image, in accordance with some embodiments discussed herein;

FIG. 12C shows the marine electronic device presenting a zoomed-in view of the partial focused 360° live sonar image from port-to-starboard of the watercraft, in accordance with some embodiments discussed herein;

FIG. 12D shows the marine electronic device presenting a partial focused 360° live sonar image, the portion being shown having been rotated to track a target object, in accordance with some embodiments discussed herein;

FIG. 13A shows an example marine electronic device presenting a 180° live sonar image from fore-to-aft of the watercraft, in accordance with some embodiments discussed herein;

FIG. 13B shows the example marine electronic device presenting a partial focused 180° live sonar image from fore-to-aft of the watercraft, in accordance with some embodiments discussed herein;

FIG. 13C shows the marine electronic device presenting a partial focused 180° live sonar image from fore-to-aft of the watercraft, in accordance with some embodiments discussed herein;

FIG. 13D shows the marine electronic device presenting a partial focused 180° live sonar image from fore-to-aft of the watercraft, in accordance with some embodiments discussed herein;

FIG. 14 is a block diagram of an example sonar system, in accordance with some embodiments discussed herein;

FIG. 15 is a block diagram of an example sonar system, in accordance with some embodiments discussed herein; and

FIG. 16 illustrates a flowchart of an example method of operating a sonar system, in accordance with some embodiments discussed herein; and

FIG. 17 illustrates a flowchart of an example method of operating a sonar system, in accordance with some embodiments discussed herein.

### DETAILED DESCRIPTION

Exemplary embodiments of the present disclosure now will be described more fully hereinafter with reference to the accompanying drawings, in which some, but not all embodiments are shown. Indeed, the present disclosure may be embodied in many different forms and should not be construed as limited to the exemplary embodiments set forth herein; rather, these embodiments are provided so that this disclosure will satisfy applicable legal requirements. Like reference numerals refer to like elements throughout.

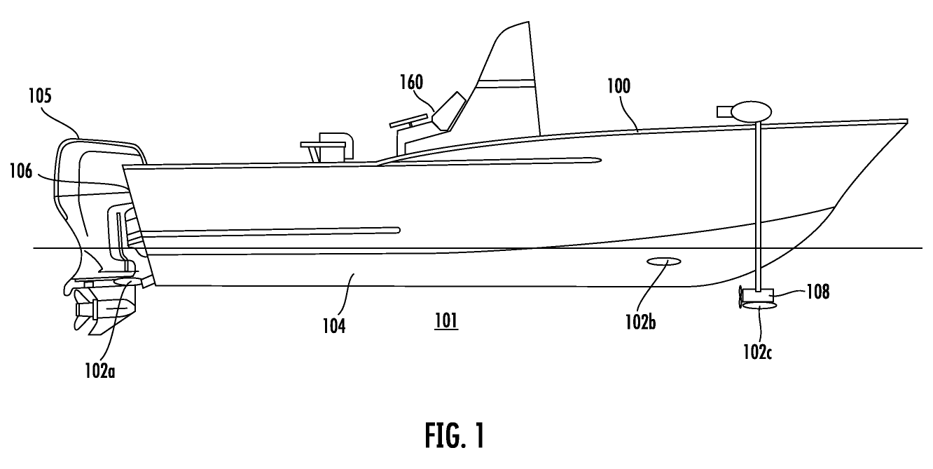

As depicted in FIG. 1, a watercraft 100 (e.g., a vessel) configured to traverse a marine environment, e.g., body of water 101, may use one or more sonar transducer assemblies 102a, 102b, and 102c disposed on and/or proximate to the watercraft. The watercraft 100 may be a surface watercraft, a submersible watercraft, or any other implementation known to those skilled in the art. The transducer assemblies 102a, 102b, and 102c may each include one or more transducer elements (such as in the form of the arrays described herein) configured to transmit sound waves into a body of water, receive sonar returns from the body of water, and convert the sonar returns into sonar return data.

Depending on the configuration, the watercraft 100 may include a main propulsion motor 105, such as an outboard or inboard motor. Additionally, the watercraft 100 may include trolling motor 108 configured to propel the watercraft 100 or maintain a position. The one or more transducer assemblies (e.g., 102a, 102b, and/or 102c) may be mounted in various positions and to various portions of the watercraft 100 and/or equipment associated with the watercraft 100. For example, the transducer assembly may be mounted to the transom 106 of the watercraft 100, such as depicted by transducer assembly 102a. The transducer assembly may be mounted to the bottom or side of the hull 104 of the watercraft 100, such as depicted by transducer assembly 102b. The transducer assembly may be mounted to the trolling motor 108, such as depicted by transducer assembly 102c.

The watercraft 100 may also include one or more marine electronic devices 160, such as may be utilized by a user to interact with, view, or otherwise control various aspects of the various sonar systems described herein. In the illustrated embodiment, the marine electronic device 160 is positioned proximate the helm (e.g., steering wheel) of the watercraft 100 – although other places on the watercraft 100 are contemplated. Likewise, additionally or alternatively, a user’s mobile device may include functionality of a marine electronic device.

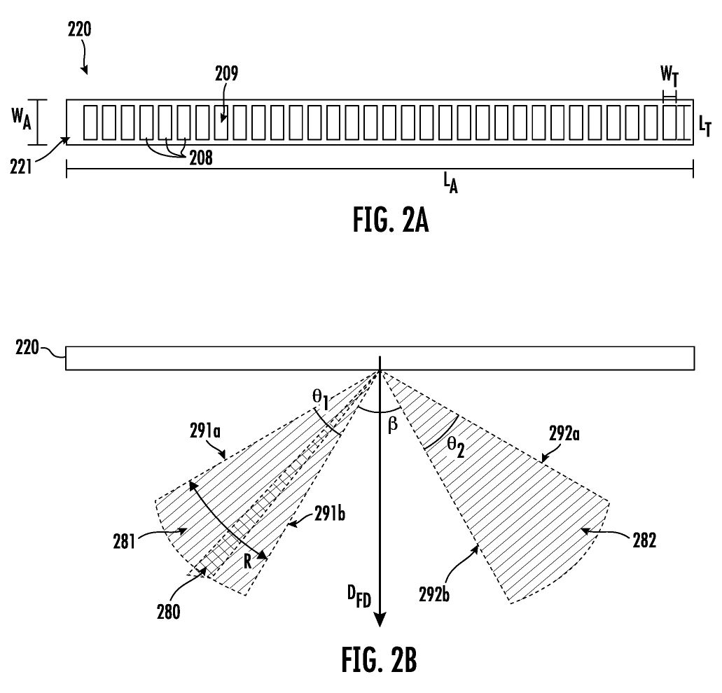

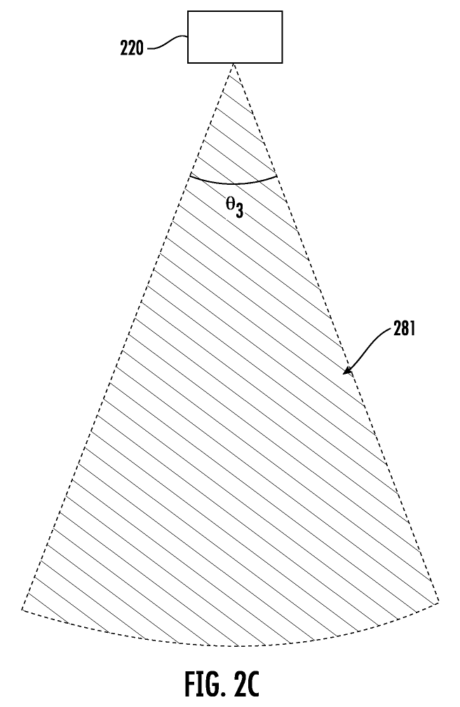

FIGS. 2A-C illustrate an example array 220 of transducer elements 208 that may be utilized with various embodiments of the present disclosure, such as within an example transducer assembly described herein. In some embodiments, the transducer array 220 may include a plurality of transducer elements 208 arranged in a line and electrically connected relative to each other. For example, the transducer elements 208 may be individually positioned on a printed circuit board (PCB). The PCB may mechanically support and electrically connect the electronic components, including the transducer elements using conductive tracks (e.g., traces), pads, and other features. The conductive tracks may comprise sets of traces; for example, each transducer elements may be mounted to the PCB such that the transducer element is in electrical communication with a set of traces. Each transducer element, sub-array, and/or the array of transducer elements may be configured to transmit one or more sonar pulses and/or receive one or more sonar return signals. Unless otherwise stated, although FIGS. 2A-C illustrate a linear array with transducer elements of a certain shape, different types of arrays (or sub-arrays), transducer elements, spacing, shapes, etc. may be utilized with various embodiments of the present disclosure.

In the illustrated embodiment shown in FIG. 2A, the transducer array 220 includes an emitting face 221 with a length L_{A} and a width W_{A}, where the length is greater than the width. Within the array 220, each transducer element 208 defines an emitting face 209 with a length L_{T} and a width W_{T}, where the length is greater than the width. The length of each transducer element 208 is perpendicular to the length of the emitting face 221. Each transducer element 208 is spaced at a predetermined distance from an adjacent transducer element, which may be designed based on desired operating characteristics of the array 220, such as described herein.

In some embodiments, the array 220 of transducer elements 208 is configured to operate to transmit one or more sonar beams into the underwater environment. Depending on the configuration and desired operation, different transmission types of sonar beams can occur. For example, in some embodiments, the array 220 may transmit sonar beams according to a frequency sweep (e.g., chirp sonar) so as to provide sonar beams into the underwater environment. In some embodiments, the array 220 may be operated to frequency steer transmitted sonar beams into various volumes of the underwater environment. In some embodiments, the array 220 may be operated to cause a broadband transmit sonar beam to be sent into the underwater environment. Depending on the frequency used and phase shift applied between transducer elements, different volumes of the underwater environment may be targeted.

In some embodiments, the array 220 may be configured to receive sonar return signals. The way the sonar return signals are received and/or processed may vary depending on the desired sonar system configuration. FIGS. 2B-2C illustrate the array 220 with example possible sonar return beam coverage according to various example embodiments. In this regard, in some embodiments, each of the plurality of transducer elements are configured to operate at a fixed phase shift (e.g., at one of 0º, π/2 radian, π/4 radian, or π/8 radian) and vary in frequency (e.g., between 500 kHz – 1200 kHz). This processing approach beamforms multiple sonar return beams (e.g., beam 280) between a first range of angles (θ₁) 281 and between a second range of angles (θ₂) 282. To explain, the sonar returns may be received by the array 220 and filtered into frequency bins based on the frequency of the signal. From that, sonar return beams 280 can be determined that provide sonar returns within a small angle window (e.g., 0.25º to 2º, although greater or lesser angle windows are contemplated). Since the mounting orientation with respect to the watercraft can be known, and the frequency is known, then the relative angle with respect to the waterline (or other reference) can be determined and used to form sonar imagery, as described herein.

With further reference to FIG. 2B, the sonar return beams (e.g., 280) can be “steered” (e.g., along arrow R) within the first range of angles 281 based on varying the frequency (e.g., between 291a and 291b). Likewise, the sonar return beams can be “steered” within the second range of angles 282 based on varying the frequency (e.g., between 292a and 292b). By operating the transducer elements at a fixed phase shift, the two range of angles 281, 282 can be covered with sonar beams, but there is also a gap (e.g., indicated by the range of angles β) that is not able to be covered by the frequency steered sonar return beams.

Without being bound by theory, a perhaps simplified explanation of this can be based on considering a single beam shape that is formed by a receipt event of the array. The beam shape is formed of a rather wide main beam lobe, along with at least one relatively small defined side lobe (e.g., the beam 280) that extends outwardly therefrom. By operating at a fixed phase shift and ignoring the main beam lobe, the sonar return signals received within the side lobe can be determined. Further, changing the frequency causes a shifting of the direction of the side lobe among the range of angles (281 or 282). Since the side lobe is symmetrical about the main lobe, there are two ranges of angles that are symmetrical about the facing direction D_{FD} of the emitting face 221 of the array 220.

Further information regarding beamforming, including frequency steered beamforming, can be found, for example, in the following: U.S. Patent No. RE45,379, entitled “Frequency Division Beamforming for Sonar Arrays”; U.S. Patent No. 10,114,119, entitled “Sonar Systems using Interferometry and/or Beamforming for 3D Imaging”; U.S. Patent 9,739,884, entitled “Systems and Associated Methods for Producing a 3D Sonar Image”; and U.S. Patent Application No. 16/382,639, published as U.S. Publication No. 2019/0265354, and entitled “Sonar Transducer Having Geometric Elements”; the contents of each hereby being incorporated by reference in their entireties.

Depending on various factors, different beam shapes can be achieved, and different ranges of angles can be achieved. The following describes some example factors that can be varied to affect the beam shapes and different ranges of angles: the number of transducer elements, the size/shape of the transducer elements, the size/shape of the array, the fixed phase shift, the frequency range, among other things. An example embodiment produces a first range of angles spanning somewhere between ~20º and ~45º, such as ~30º, and a second range of angles spanning somewhere between ~20º and ~45º, such as ~30º, with a gap of range of angles therebetween of somewhere between ~25º and ~65º, such as ~45º. Additionally, sonar return beams of ~0.25º to 2º are formed. Further, with reference to FIG. 2C, a transverse beamwidth θ₃ of somewhere between ~10º and ~45º, such as ~20º, is formed. Some example embodiments that may achieve such example beam shapes include an array length of between ~100-150 mm; an array width of between ~3-10 mm; an array thickness of between ~1-3 mm; a number of transducer elements of between 50-200; a width of the transducer element of between ~0.4-1 mm; and a length of the transducer element of between ~2-10 mm (although outside of these ranges is also contemplated).

In some embodiments, the marine electronic device may be configured to utilize more than one array, where the arrays are oriented relative to each other to provide a desired sonar beam coverage volume of a certain portion of the underwater environment. For example, in some embodiments, multiple array(s) can be positioned and oriented relative to each other such that the ranges of angles of each array cover (e.g., overlap with) the gap ranges of angles of other arrays to provide 360° coverage of the underwater environment. As described herein, various different configurations of multiple arrays may be used to achieve such 360° coverage. For example, in some embodiments, all of the arrays may lay in a same plane, while in other embodiments, multiple arrays may be stacked or otherwise vertically displaced such that different arrays lay in different planes.

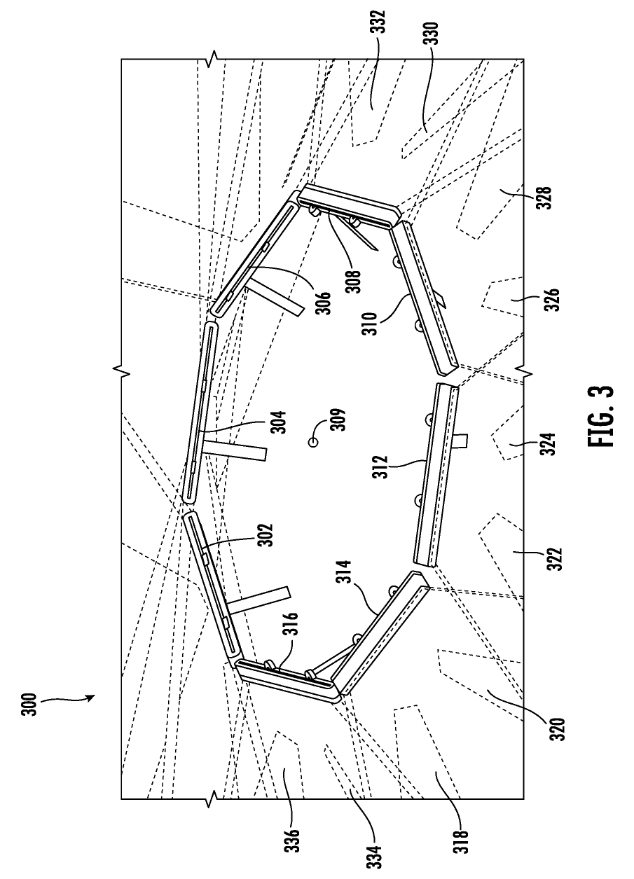

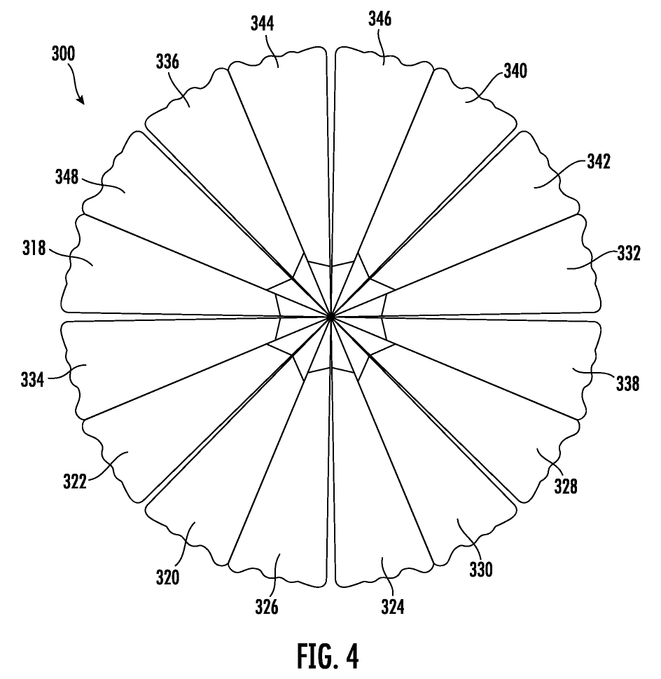

FIGS. 3-5 illustrate an example transducer assembly 300 that is designed to provide 360° sonar coverage utilizing beamformed sonar return beams. As best shown in FIG. 3, the transducer assembly 300 includes a first array 302, a second array 304, a third array 306, a fourth array 308, a fifth array 310, a sixth array 312, a seventh array 314, and an eighth array 316. The arrays are positioned in a circumferential pattern around a center point 309 such that the arrays are aimed outwardly and downwardly from the center point. In some embodiments, the arrays are positioned within a housing. The first array 302 is oriented with a facing direction so as to produce a first range of angles 348 and a second range of angles 346 (with a gap in between). The second array 304 is oriented with a facing direction so as to produce a first range of angles 344 and a second range of angles 342 (with a gap in between). The third array 306 is oriented with a facing direction so as to produce a first range of angles 340 and a second range of angles 338 (with a gap in between). The fourth array 308 is oriented with a facing direction so as to produce a first range of angles 332 and a second range of angles 330 (with a gap in between). The fifth array 310 is oriented with a facing direction so as to produce a first range of angles 328 and a second range of angles 326 (with a gap in between). The sixth array 312 is oriented with a facing direction so as to produce a first range of angles 324 and a second range of angles 322 (with a gap in between). The seventh array 314 is oriented with a facing direction so as to produce a first range of angles 320 and a second range of angles 318 (with a gap in between). The eighth array 316 is oriented with a facing direction so as to produce a first range of angles 334 and a second range of angles 336 (with a gap in between).

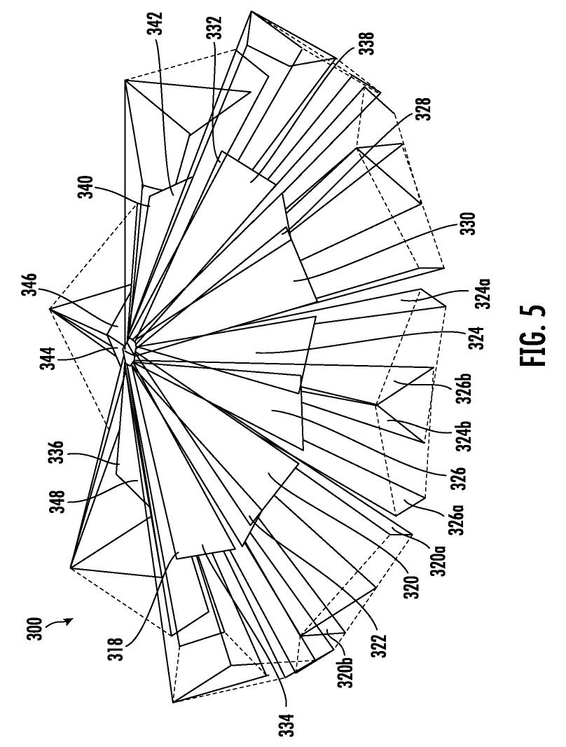

In some embodiments, each of the sonar return beams may have a low frequency end and a high frequency end, and the arrays may be configured such that the low frequency end of each of the multiple sonar return beams is adjacent to a low frequency end of a first adjacent sonar beam and such that the high frequency end of each of the multiple sonar return beams is adjacent to a high frequency end of a second adjacent sonar beam. For example, in the embodiment shown in FIG. 5, the second range of angles 326 of the fifth array 310 has a high frequency end 326a and a low frequency end 326b. The first range of angles 324 of the sixth array 312 has a high frequency end 324a and a low frequency end 324b, and first range of angles 320 of the seventh array 314 has a high frequency end 320a and a low frequency end 320b. The low frequency ends 324b and 326b are adjacent to each other, and the high frequency ends 320a and 326a are adjacent to each other. Such a configuration allows a 360° sonar image that is formed using the plurality of sonar transducer arrays to be continuous, and which has improved transitions between portions of the sonar image. For example, in the event where a high frequency end may lie adjacent a low frequency end, there may be a more distinct difference in the sonar imagery corresponding to the high frequency end and the sonar imagery corresponding to the low frequency end – which leads to abrupt changes within an otherwise continuous sonar image. Instead, putting like frequencies adjacent each other leads to a smoother transition between sonar image portions.

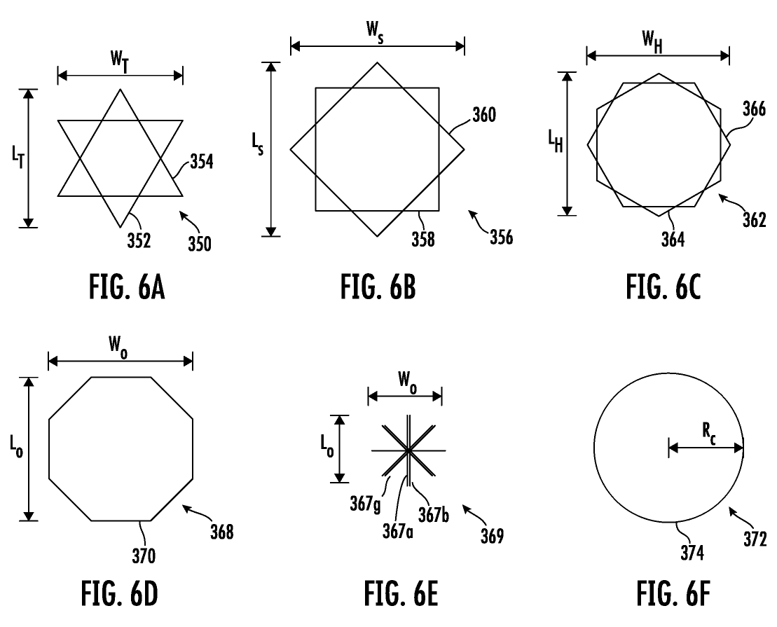

Referring now to FIGS. 6A-6E, a transducer assembly may have multiple sonar transducer arrays, and the sonar transducer arrays may be arranged in various different configurations to achieve the 360° coverage. The arrays may be positioned in a circumferential pattern around a center point such that the arrays are aimed outwardly and downwardly from the center point, and in some embodiments, the arrays may be positioned within a housing. For example, referring to FIG. 6A, a transducer assembly 350 comprises six sonar transducer arrays, and the six sonar transducer arrays are configured in a triangular stacked arrangement. A first three sonar transducer arrays 354 may lay in a first plane, while a second three sonar transducer arrays 352 may lay in a second plane. The first three sonar transducer arrays 354 and the second three sonar transducer arrays 352 may be oriented such that the points of the triangular shape of the first three sonar transducer arrays 354 do not overlap the points of the triangular shape of the second three sonar transducer arrays 352. In the embodiment shown in FIG. 6A, the first three sonar transducer arrays 354 all lay in a first plane, e.g., parallel to a surface of a body of water, and the second three sonar transducer arrays 352 lay in a second plane, e.g., also parallel to the surface of the body of water; and the first and second planes are separated by a distance, such as 3 inches, 6 inches, 2 cm, 5 cm, 2 mm, etc. In other embodiments, the six (or more) sonar transducer arrays may lay in more than two planes which may or may not be parallel to a surface of a body of water. Along similar lines, more than 2 triangular (or other shapes) could be provided. Further, the first and second three sonar transducer arrays 354, 352 may be oriented in any other manner with respect to each other.

Referring now to FIG. 6B, a transducer assembly 356 comprises eight sonar transducer arrays, and the eight sonar transducer arrays may be configured in a rectangular stacked arrangement. A first four sonar transducer arrays 358 may lay in a first plane, while a second four sonar transducer arrays 360 may lay in a second plane. The first four sonar transducer arrays 358 and the second four sonar transducer arrays 360 may be oriented such that the points of the rectangular shape of the first four sonar transducer arrays 358 do not overlap the points of the rectangular shape of the second four sonar transducer arrays 360. In the embodiment shown in FIG. 6B, the first four sonar transducer arrays 358 all lay in a first plane, e.g., parallel to a surface of a body of water, and the second four sonar transducer arrays 360 lay in a second plane, e.g., also parallel to the surface of the body of water, and the first and second planes are separated by a distance, such as 3 inches, 6 inches, 2 cm, 5 cm, 2 mm, etc. In other embodiments, the eight sonar transducer arrays may lay in more or less than two planes which may or may not be parallel to a surface of a body of water. Along similar lines, more than 2 squares (or other shapes) could be provided. Further, the first and second three sonar transducer arrays 358, 360 may be oriented in any other manner with respect to each other.

Referring now to FIG. 6C, a transducer assembly 362 comprises twelve sonar transducer arrays, and the twelve sonar transducer arrays are configured in a hexagonal stacked arrangement. A first six sonar transducer arrays 364 may lay in a first plane, while a second six sonar transducer arrays 366 may lay in a second plane. The first six sonar transducer arrays 364 and the second six sonar transducer arrays 366 may be oriented such that the points of the hexagonal shape of the first six sonar transducer arrays 364 do not overlap the points of the hexagonal shape of the second six sonar transducer arrays 366. In the embodiment shown in FIG. 6C, the first six sonar transducer arrays 364 all lay in a first plane, e.g., parallel to a surface of a body of water, and the second six sonar transducer arrays 366 lay in a second plane, e.g., also parallel to the surface of the body of water, and the first and second planes are separated by a distance, such as 3 inches, 6 inches, 2 cm, 5 cm, 2 mm, etc. In other embodiments, the twelve sonar transducer arrays may lay in more or less than two planes which may or may not be parallel to a surface of a body of water. Along similar lines, more than 2 hexagons (or other shapes) could be provided. Further, the first and second three sonar transducer arrays 364, 366 may be oriented in any other manner with respect to each other.

Referring next to FIG. 6D, a transducer assembly 368 comprises eight sonar transducer arrays 370, and the eight sonar transducer arrays 370 are configured in an octagonal arrangement. In the embodiment shown in FIG. 6D, the eight sonar transducer arrays in the transducer assembly 368 lay in a same plane. For example, the transducer assembly 368 may be configured similar (or identical) to the embodiment shown in FIGS. 3-5. In other embodiments, the eight sonar transducer arrays may lay in more than one plane which may or may not be parallel to a surface of a body of water. Further, the eight sonar transducer arrays may be oriented in any other manner with respect to each other.

Referring next to FIG. 6E, a transducer assembly 369 comprises eight sonar transducer arrays 367a, 367b…367g. Notably, the eight sonar transducer arrays 367a, 367b…367g are stacked in multiple “star” style configurations, specifically shown as two eight leg stars where four arrays form an eight leg star. The two eight leg stars are stacked in different planes relative to each other. Notably, however, the transducer arrays are directed to provide 360° coverage as described herein. For example, transducer array 367a is aimed to the left, while transducer array 367b is aimed to the right.

Referring now to FIG. 6F, a transducer assembly 372 comprises one or more sonar transducer arrays configured in a circumferential configuration 374. In some embodiments, the one or more sonar transducer arrays may all lay in the same plane. In other embodiments, the one or more sonar transducer arrays may lay in different planes. For example, the one or more sonar transducer arrays may be configured in a spiralized cylindrical pattern along the circumferential configuration 374. Further, the one or more sonar transducer arrays may be oriented in any other manner with respect to each other within the circumferential configuration 374.

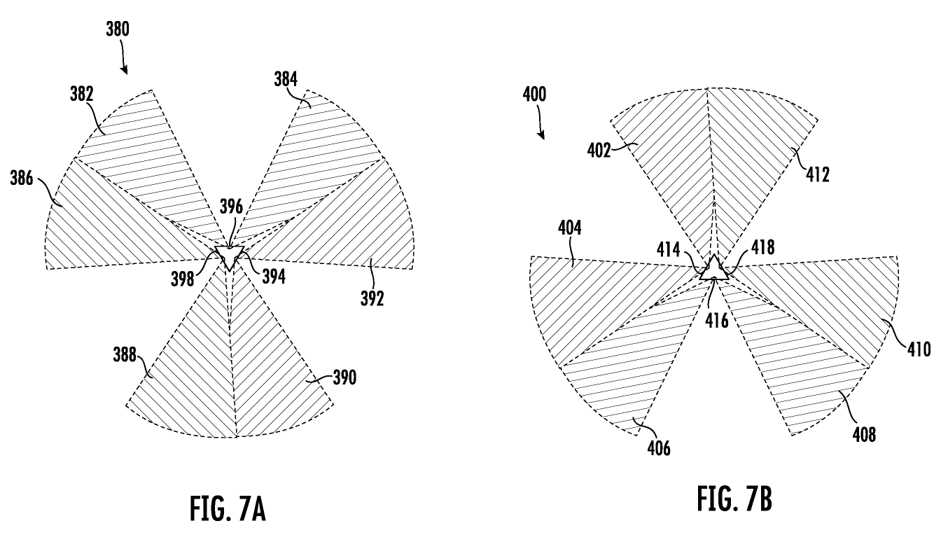

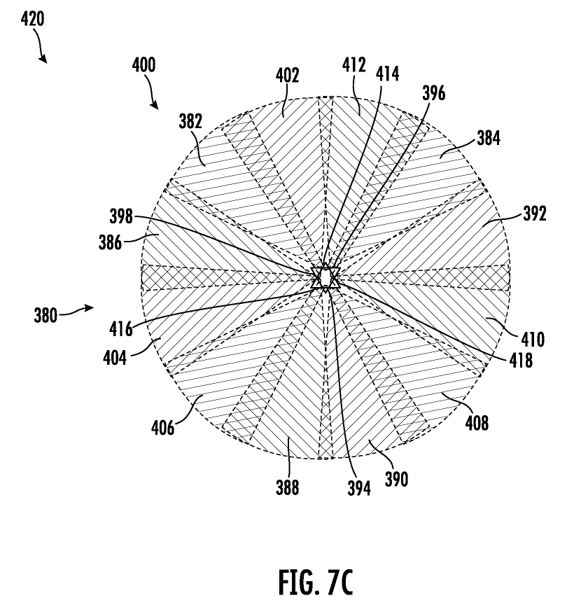

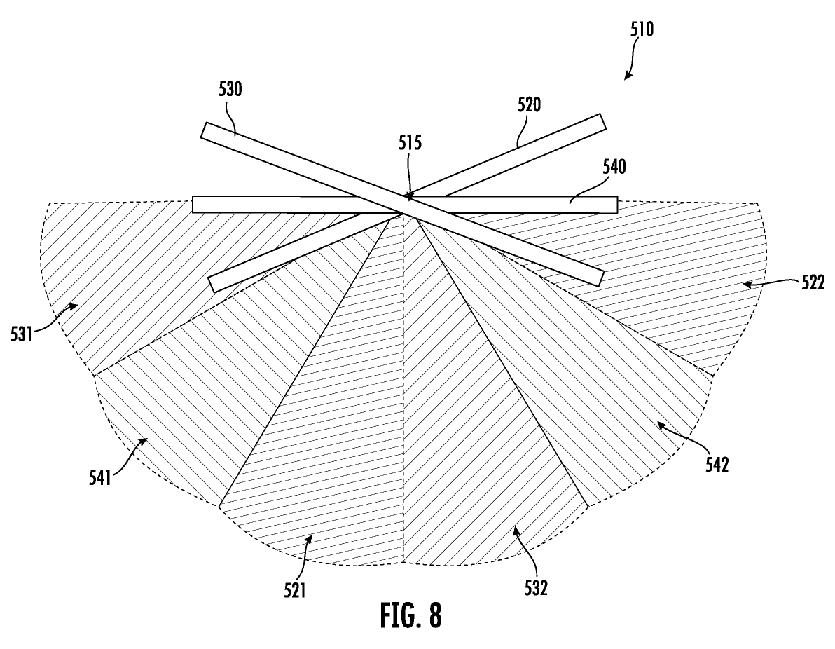

FIGS. 7A-7C illustrate an example transducer assembly 420 with six sonar transducer arrays arranged in a triangular stacked configuration, such as shown in FIG. 6A. In some embodiments, the arrays are positioned within a housing. As best shown in FIG. 7A, the transducer assembly 420 comprises three first sonar transducer arrays 380 (sonar transducer arrays 394, 396, and 398) arranged in a same plane in a triangular configuration. The three first sonar transducer arrays 380 are positioned in a circumferential pattern around a center point such that the arrays are aimed outwardly and downwardly from the center point (although any direction is contemplated, such as just outwardly). Each of the three first sonar transducer arrays 380 are configured to produce two ranges of angles with a gap in between. For example, the first array 394 is oriented with a facing direction so as to produce a first range of angles 390 and a second range of angles 392 (with a gap in between). The second array 396 is oriented with a facing direction so as to produce a first range of angles 384 and a second range of angles 382 (with a gap in between). The third array 398 is oriented with a facing direction so as to produce a first range of angles 386 and a second range of angles 388 (with a gap in between).

As best shown in FIG. 7B, the transducer assembly 420 comprises three second sonar transducer arrays 400 (sonar transducer arrays 414, 416, and 418) arranged in a same plane in a triangular configuration. In some embodiments, the plane in which the three second sonar transducer arrays 400 lay is parallel to the plane in which the three first sonar transducer arrays 380 lay. The three second sonar transducer arrays 400 are positioned in a circumferential pattern around a center point such that the arrays are aimed outwardly and downwardly from the center point (although any direction is contemplated, such as just outwardly). Each of the three second sonar transducer arrays 400 are configured to produce two ranges of angles with a gap in between. For example, the first array 414 is oriented with a facing direction so as to produce a first range of angles 402 and a second range of angles 404 (with a gap in between). The second array 416 is oriented with a facing direction so as to produce a first range of angles 406 and a second range of angles 408 (with a gap in between). The third array 418 is oriented with a facing direction so as to produce a first range of angles 410 and a second range of angles 412 (with a gap in between).

As best shown in FIG. 7C, the three first sonar transducer arrays 380 and the three second sonar transducer arrays 400 are arranged in a stacked configuration. More specifically, in the embodiment shown in FIG. 7C, the three first sonar transducer arrays 380 and the three second sonar transducer arrays 400 are arranged such that the peaks of the triangular shape of the three first sonar transducer arrays 380 are offset from the peaks of the triangular shape of the three second sonar transducer arrays 400. This configuration causes the ranges of angles of the three first sonar transducer arrays 380 and the three second sonar transducer arrays 400 to fit together so as to provide 360° coverage. For example, the ranges of angles 402 and 412 of the arrays 414 and 418, respectively, are oriented such that they cover the gap between the ranges of angles 382 and 384 of the array 396. The ranges of angles 410 and 408 of the arrays 418 and 416, respectively, are oriented such that they cover the gap between the ranges of angles 392 and 390 of the array 394. The ranges of angles 404 and 406 of the arrays 414 and 416, respectively, are oriented such that they cover the gap between ranges of angles 386 and 388 of the array 398. Similarly, the ranges of angles 386 and 382 of the arrays 398 and 396, respectively, are oriented such that they cover the gap between ranges of angles 404 and 402 of the array 414. The ranges of angles 384 and 392 of the arrays 396 and 394, respectively, are oriented such that they cover the gap between ranges of angles 412 and 410 of the array 418. The ranges of angles 390 and 388 of the arrays 394 and 398, respectively, are oriented such that they cover the gap between ranges of angles 408 and 406 of the array 416.

Although the three first sonar transducer arrays 380 and the three second sonar transducer arrays 400 are separated such that the three first sonar transducer arrays 380 lay in a first plane and the three second sonar transducer arrays 400 lay in a second plane, the ranges of angles are still able to cover the gaps between other ranges of angles to form the 360° view shown in FIG. 7C. That is, the distance between the planes in which the three first sonar transducer arrays 380 and the three second sonar transducer arrays 400 lay is small enough such that the ranges of angles converge into the 360° coverage at an appropriate distance from a center point of the transducer assembly 420. For example, in some embodiments, the distance between the planes in which the three first sonar transducer arrays 380 and the three second sonar transducer arrays 400 lay may be approximately three inches. In other embodiments, however, the distance may be more or less than three inches.

FIG. 8 illustrates an example three array assembly 510 that is designed to provide continuous sonar coverage utilizing beamformed sonar return beams. The sonar assembly 510 includes a first array 540, a second array 530, and a third array 520. The first array 540 is oriented with a facing direction (e.g., substantially straight down relative to the figure) so as to produce a first range of angles 541 and a second range of angles 542 (with a gap in between). The second array 530 is oriented with a facing direction at an angle (e.g., -30º relative to the facing direction of the first array 540) so as to produce a first range of angles 531 and a second range of angles 532 (with a gap in between). The third array 520 is oriented with a facing direction at another angle (e.g., +30º relative to the facing direction of the first array 540) so as to produce a first range of angles 521 and a second range of angles 522 (with a gap in between). As so arranged, the gaps between each set of the two range of angles are covered by a range of angles from each of the other two arrays. The illustrated example thus provides continuous sonar beam coverage for ~180º.

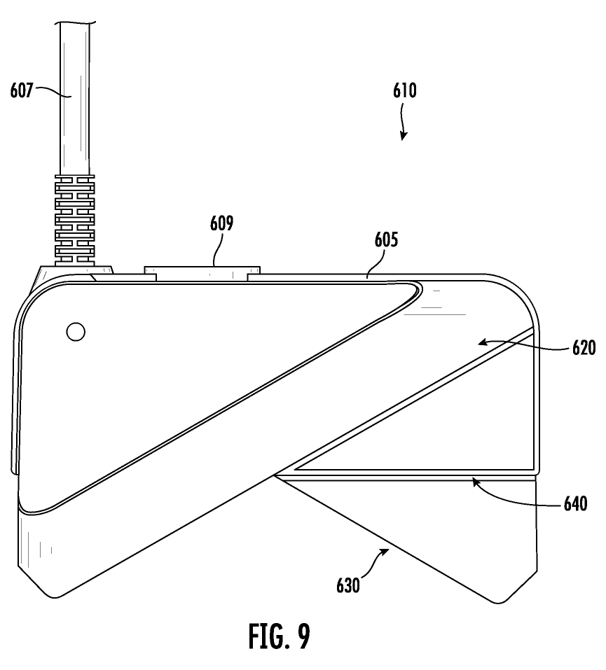

FIG. 9 illustrates an example transducer assembly 610 including a housing 605 that houses the three arrays 620, 630, 640. The housing 605 includes a mounting feature 609 (e.g., a ratchet-type mounting feature for enabling secured attachment in different orientations). Notably, the mounting feature 609 is positioned on a top portion of the transducer assembly 610, such as may be beneficially placed to interact with an arm portion of example bracket assemblies described herein. This may enable single handed re-orientation, particularly in situations where the transducer assembly 610 may be dimensionally re-oriented relative to the arm portion as well (such as switching between an example downward orientation and a forward orientation). The cable 607 provides a safe channel for running various wires used in conjunction with the sonar system.

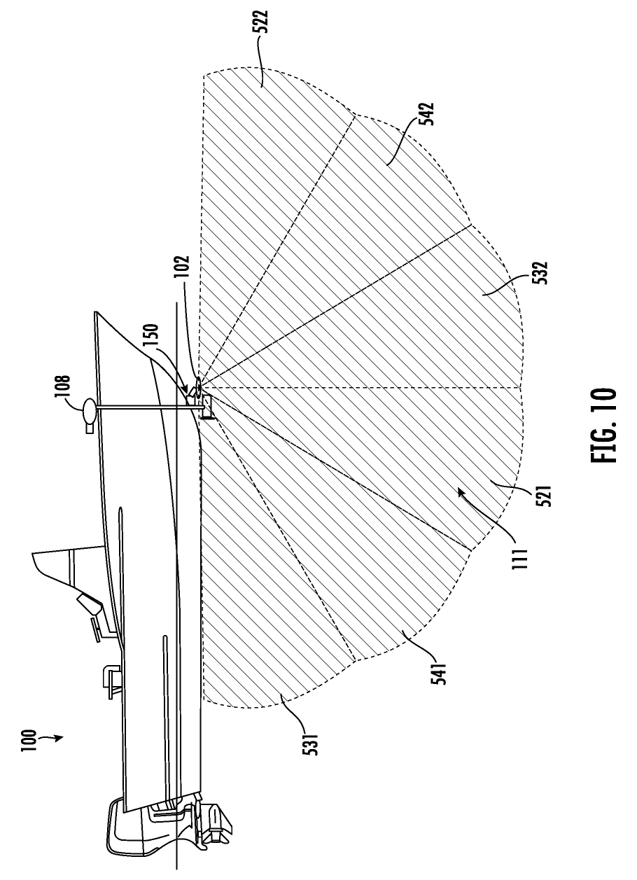

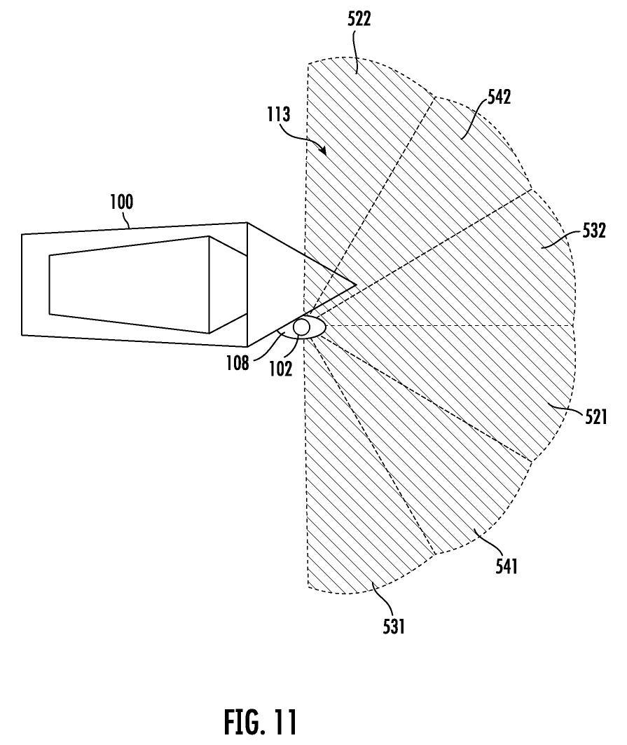

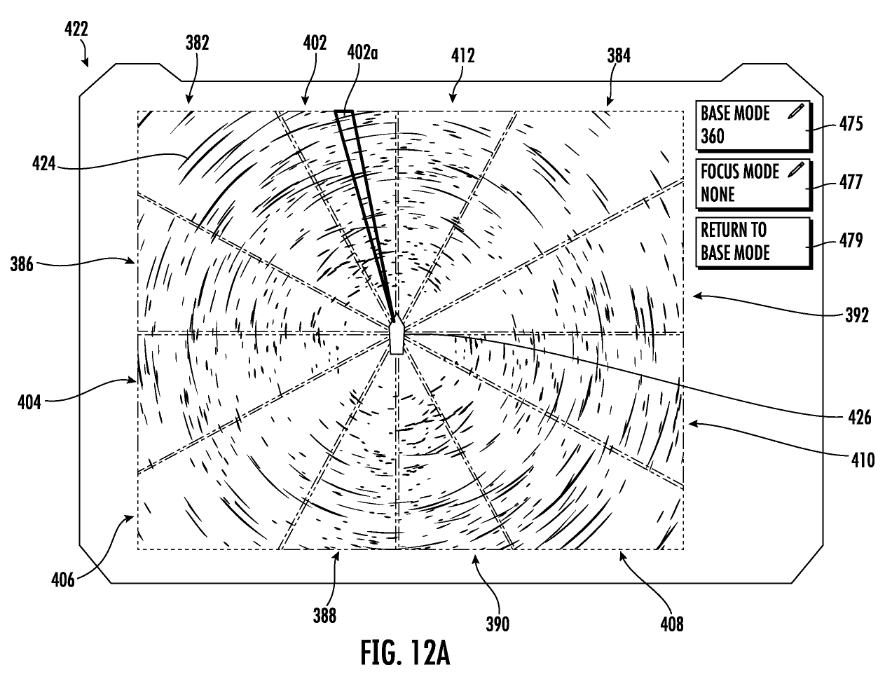

FIG. 10 illustrates a watercraft 100 with an example transducer assembly 102 that is mounted to a trolling motor 108 using an example bracket assembly 150. Notably, the transducer assembly 102 is utilizing three arrays to provide continuous sonar coverage 111 in the downward direction relative to the watercraft 100 (e.g., the transducer assembly 102 is in the downward orientation). In this regard, the three arrays work together to provide corresponding ranges of angles (e.g., 531, 541, 521, 532, 542, and 522) that cover the 180°. In the illustrated embodiments, the lengths of each of the emitting faces of the three arrays extends in the fore-to-aft perspective of the watercraft (e.g., the transducer assembly 102 extends in a dimensional orientation that is parallel with a centerline of the watercraft 100). Accordingly, the transducer assembly 102 can be used to form a live (or substantially real-time) two-dimensional (2D) sonar image (e.g., time/distance from the transducer assembly and angle) corresponding to below the watercraft from the fore-to-aft perspective.

As noted herein, however, by changing the orientation of the transducer assembly, different regions of the underwater environment relative to the watercraft may be covered by the sonar – thereby producing a different type of live sonar image. For example, with reference to FIG. 11, which is a plan view of the watercraft 100, the transducer assembly 102 has been re-oriented (e.g., using the bracket assembly 150 mounted to the trolling motor 108) to provide continuous sonar coverage 113 in the forward direction relative to the watercraft 100 (e.g., the transducer assembly 102 is in the forward orientation). In that orientation, the three arrays still work together to provide corresponding ranges of angles (e.g., 531, 541, 521, 532, 542, and 522) that cover the 180°. However, here, the lengths of each of the emitting faces of the three arrays extend in the port-to-starboard perspective of the watercraft (e.g., the transducer assembly 102 extends in a dimensional orientation that is perpendicular with the centerline of the watercraft 100). Accordingly, the transducer assembly 102 can be used to form a live (or substantially real-time) two-dimensional (2D) sonar image (e.g., time/distance from the transducer assembly and angle) corresponding to in front of the watercraft from the fore-to-aft perspective. Notably, the change in orientation causes a different viewpoint of sonar imagery to be provided to the user (e.g., a sweeping view from the left to right in front of the watercraft). Although the downward direction and forward direction are illustrated here, other directions and regional underwater coverage options are contemplated by various embodiments of the present invention, and these are just a couple of desirable sonar view options that correspond to sonar system orientations.

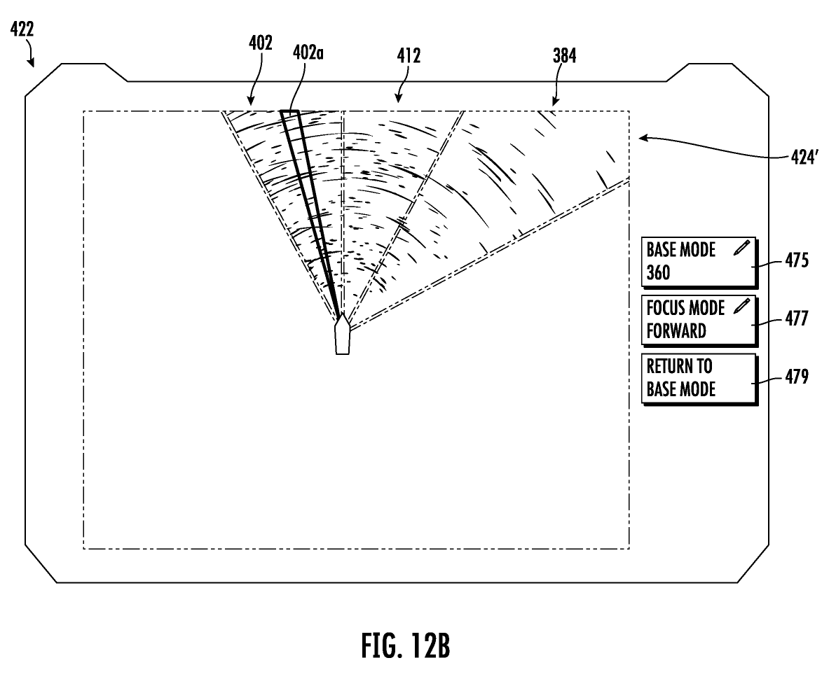

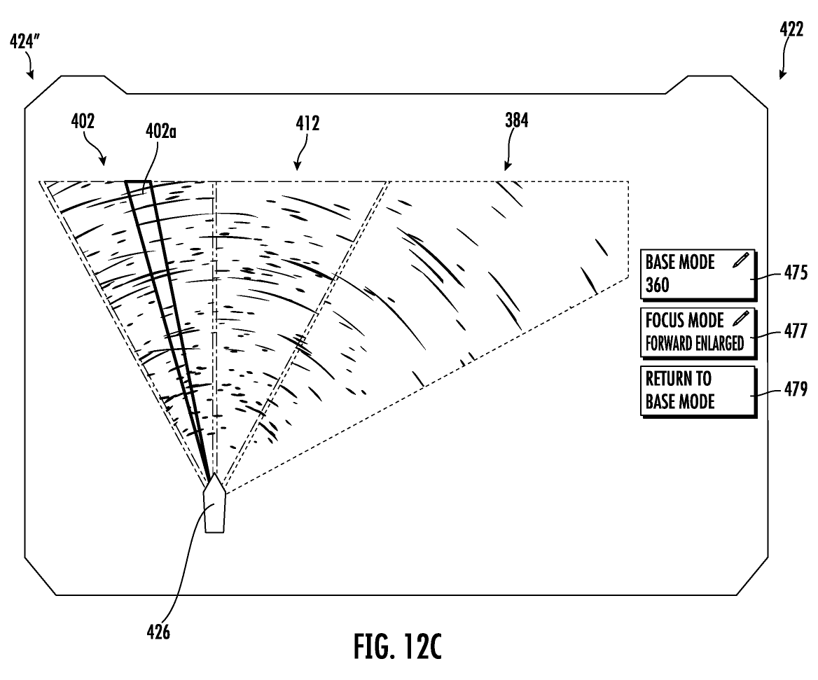

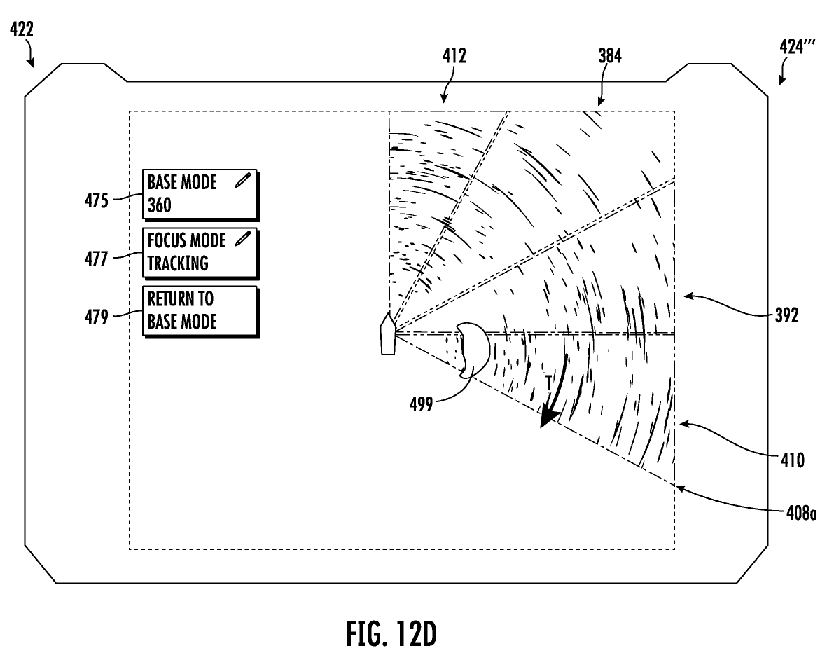

In some embodiments, the arrays can be used to form 360° live (or substantially real-time) sonar images. For example, FIG. 12A illustrates a 360° live sonar image 424 presented on a display of a marine electronics device 422. The 360° live sonar image 424 illustrates a depiction of the underwater environment with a watercraft icon 426 overtop. The 360° live sonar image 424 is formed as slices of sonar return data corresponding to each sonar return beam extending within a sonar beam coverage. For example, the 360° live sonar image 424 may be formed as slices of sonar return data corresponding to each sonar return beams extending within the sonar beam coverages defined by the ranges of angles 412, 384, 392, 410, 408, 390, 388, 406, 404, 386, 382, and 402 shown in FIGS. 7A-7C (which are illustrated overlaid on the sonar image 424 in FIG. 12A). To further explain, each slice of sonar beam coverage (e.g., slice 402a) within each range of angles can be formed into sonar imagery and placed on the screen simultaneously to form the 360° sonar image 424. In this regard, the 360° live sonar image 424 can be updated in substantially real-time all at once as it was all received at substantially the same time (e.g., by selecting different frequencies to form all the different sonar return beams that are used to present sonar return data into the image at the proper angle). Notably, any number of ranges of angles may be used to form the sonar image – such as generated by other transducer array arrangements, some of which may described herein.

Further, in some embodiments, the arrays can be used to form partial (e.g., less than 360°) live (or substantially real-time) sonar images. In some embodiments, the partial live sonar image may be formed as slices of sonar return data corresponding to some of all of the available sonar return beams (e.g., including full or partial portions of ranges of angles). For example, with reference to FIG. 12B, a partial live sonar image 424’ may be formed as slices of sonar return data corresponding to each sonar return beam extending within the sonar beam coverages defined by the ranges of angles 402, 412, and 384 in FIG. 7C. In this regard, the partial live sonar image can be updated in substantially real-time all at once as it was all received at substantially the same time (e.g., by selecting different frequencies to form all the different sonar return beams that are used to present sonar return data into the image at the proper angle(s)). In some embodiments, the marine electronic device may be configured to present a zoomed-in version of the partial live sonar image, as more display space may be available. For example, FIG. 12C illustrates an example zoomed-in partial live sonar image 424’’.

In some embodiments, the user may select the portions of the 360° sonar image that will form the partial live sonar image. Such a selection may be made at the marine electronic device and may include any form of selection (e.g., using a finger to define the portion, selecting and/or inputting angles of the 360°s, among other ways). In some embodiments, the presented portions forming the partial live sonar image may be based on sweep pattern(s) and/or position(s) of desired target(s) within the underwater environment (e.g., stationary target(s) and/or moving target(s)). For example, with reference to FIG. 12D, a desired object 499 may be identified, and the sonar return data may be used to create the partial live sonar image by automatically and/or continually updating which portions of the sonar beam coverage to display such that the object 499 remains within the partial live sonar image over time. For example, the selected sonar beam slices for presentation have shifted clockwise (e.g., along arrow T). In this regard, the range of angles 412, 384, and 392 are presented along with a slice 408a from another range of angles 408. Notably, the object 499 is still shown in the partial live sonar image 424’’’. In some embodiments, the user may select the object to be tracked, although the object may be automatically determined in other embodiments.

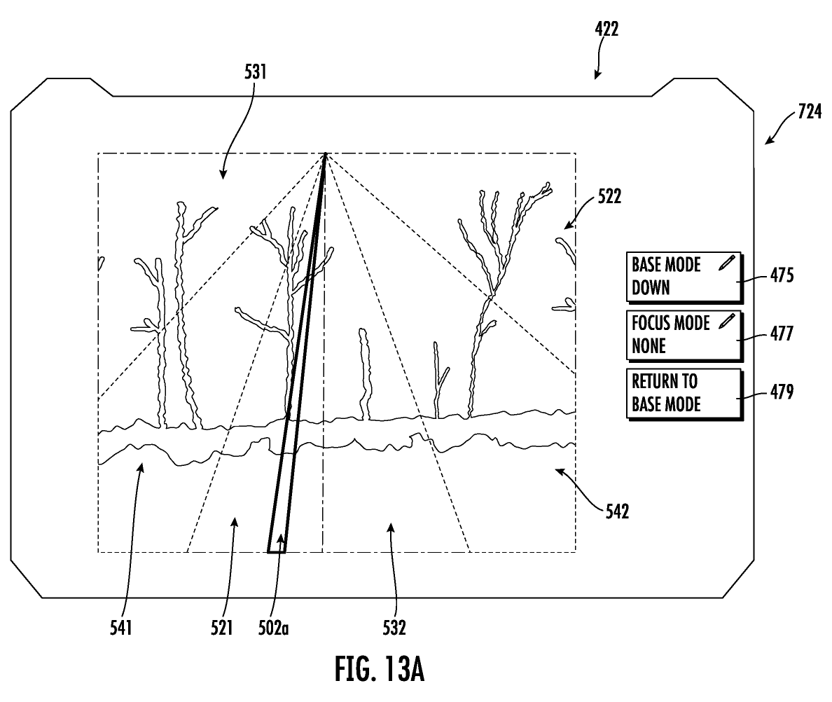

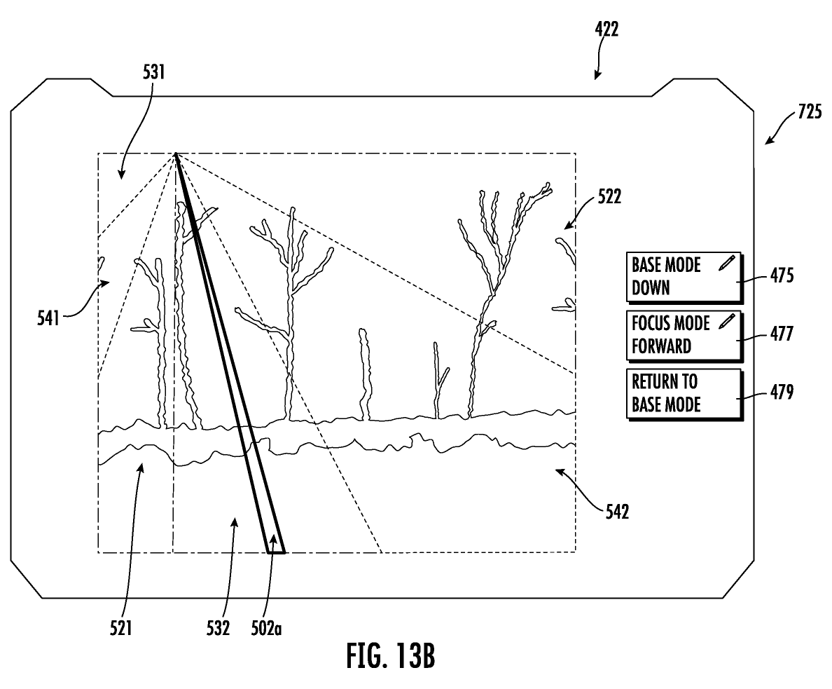

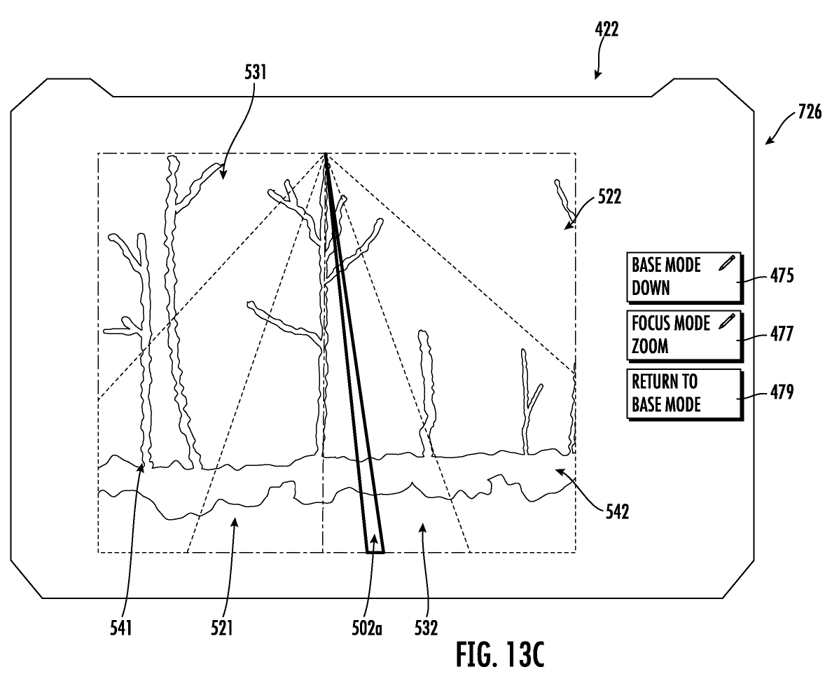

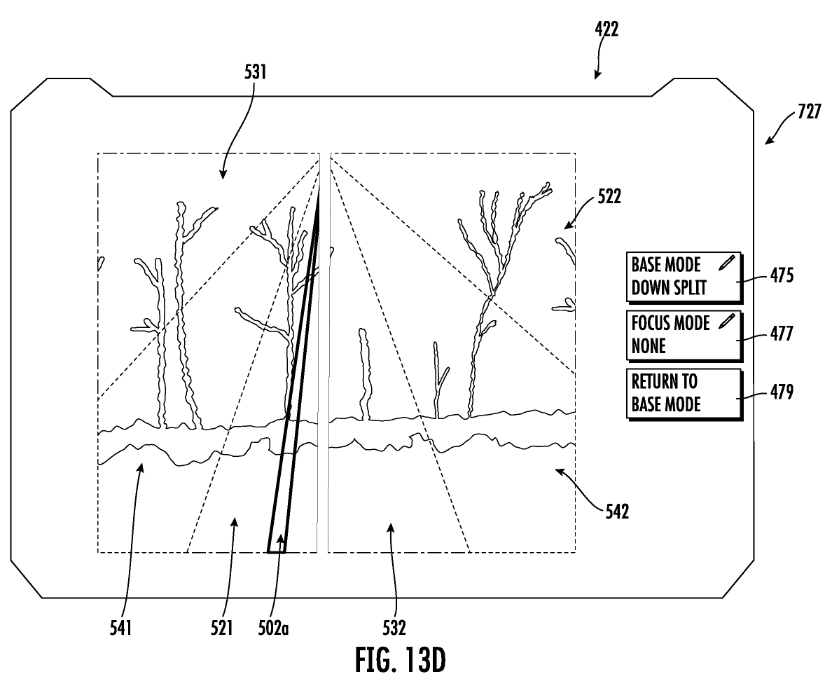

In some embodiments, various one or more sonar transducer assemblies, such as the transducer assembly 610 shown in FIG. 9, can be used to form 180° live (or substantially real-time) sonar images. For example, FIG. 13A illustrates a 180° live sonar image 724 presented on a display of a marine electronic device 422. The 180° live sonar image 724 illustrates a depiction of the underwater environment. The 180° live sonar image 724 is formed as slices of sonar return data corresponding to each sonar return beam extending within a sonar beam coverage. For example, the 180° live sonar image 724 may be formed as slices of sonar return data corresponding to each sonar return beam extending within the sonar beam coverages defined by the ranges of angles 541, 542, 531, 532, and 521, 522 shown in FIG. 10 (which are illustrated overlaid on the sonar image 724 in FIG. 13A). To further explain, each slice of sonar beam coverage (e.g., slice 502a) within each range of angles can be formed into sonar imagery and placed on the screen simultaneously to form the 180° sonar image 724. In this regard, the 180° live sonar image 724 can be updated in substantially real-time all at once as it was all received at substantially the same time (e.g., by selecting different frequencies to form all the different sonar return beams that are used to present sonar return data into the image at the proper angle). Notably, any number of ranges of angles may be used to form the sonar image, such as generated by other transducer array arrangements, some of which may be described herein.

In some embodiments, the user interface is configured to present one or more selectable interface elements associated with display mode selection. In the illustrated embodiment, the base display mode selectable interface element 475 is shown with the down mode in the fore to aft perspective is selected with no focused display mode being selected. The sonar image 724 therefore corresponds to the full 180° coverage of the underwater environment in the down mode, here depicted in the fore-to-aft perspective under the watercraft. Other selectable base display modes may include, for example, a 180° coverage in the down mode in the port-to-starboard perspective, 360° coverage mode around the perimeter of the watercraft, as illustrated in FIGS. 12A, 180° coverage mode around the fore or front perimeter of the watercraft, 180° coverage mode around the aft or rear perimeter of the watercraft, or the like.

In some embodiments, the user may interact with the focused display mode selectable interface element 477 to explore different focused sonar views within the selected base display mode. Exemplary focused display modes may be forward mode which biases the display to the front of the watercraft/sonar system, backward mode which biases the display to the rear of the watercraft/sonar system, down focused mode which biases the display underneath the watercraft/sonar system, or other suitable sonar visualization modes.

The return-to-base interface element 479 provides a convenient mechanism for the user to quickly revert the sonar image presentation to the full base display mode (e.g., down mode), thereby restoring the complete sonar coverage view (although in some embodiments, the first selectable interface element 475 may return the use to base display mode).

In some embodiments, the various one or more sonar transducer assemblies can be used to form partial (e.g., a focused or subset image of the full 180° image) live (or substantially real-time) sonar images. For example, with reference to FIG. 13B, a partial live sonar image 725 may be formed as slices of sonar return data corresponding to each sonar return beam extending within the sonar beam coverages defined by the ranges of angles shown in FIG. 10. In the illustrated embodiment, the origin of the angles has shifted rearward (e.g., to the left of the image), and only a portion of the sonar image corresponding to the ranges of angles 521, 531, and 541 is presented. The sonar image 725 includes an enlarged depiction of the sonar return data corresponding to the selected forward portion of the underwater environment.

In this regard, the partial live sonar image 725 can be updated in substantially real-time all at once as it was all received at substantially the same time (e.g., by selecting different frequencies to form all the different sonar return beams that are used to present sonar return data into the image at the proper angle(s)). In some embodiments, the marine electronic device may be configured to present a magnified focused version of the partial live sonar image, as more display space may be available.

In the illustrated embodiment, the user interface configured to present one or more selectable interface elements associated with display mode selection. In the illustrated embodiment, the base display mode selectable interface element 475 is shown with the down mode selected and the focused display mode selectable interface element 477 is shown with a forward-biased focused mode selected.

FIG. 13C illustrates a marine electronic device 422 presenting a partial and magnified live sonar image 726 formed as slices of sonar return data corresponding to each sonar return beam extending within the sonar beam coverages defined by the ranges of angles 541, 542, 531, and 532 shown in FIG. 10 (which are illustrated overlaid on the sonar image 726 in FIG. 13C). In the illustrated embodiment, the sonar image 726 corresponds to a zoomed-in focused display mode within the downward-facing base display mode (i.e., the down mode). The zoomed-in display mode presents a magnified view of the underwater environment focused beneath the watercraft. In the example, the base display mode selectable interface element 475 is shown with the down mode selected and the focused display mode selectable interface element 477 is shown with a zoomed-in region selected, corresponding to the portion of the underwater environment directly beneath the watercraft.

FIG. 13D illustrates a split 180° live sonar image 727 presented on a display of a marine electronic device 422. The split 180° live sonar image 727 illustrates a depiction of the underwater environment. The sonar image 727 corresponds to the same sonar return data and beam coverage as described with respect to FIG. 13A, including the ranges of angles 541, 542, 531, 532, and 521, 522 shown in FIG. 10 (which are illustrated overlaid on the sonar image 727 in FIG. 13D). In the illustrated embodiment, the sonar image 727 is presented in a split format, wherein the fore and aft portions of the sonar image are visually separated. This split presentation may be beneficial for user interaction, particularly in embodiments where the marine electronic device 422 includes a touch-sensitive display. For example, the user may interact directly with either the forward or rear portion of the sonar image to select a corresponding focused display mode. Such interaction may serve as an alternative to using the second selectable interface element 477 to select a focused display mode.

In some embodiments, the split format may include a depicted boundary between slices associated with the fore and aft of the watercraft, thereby visually distinguishing the directional sonar coverage regions. The user interface may further include the first selectable interface element 475 corresponding to the base display mode selection, the second selectable interface element 477 corresponding to the focused display mode selection, and the third selectable interface element 479 configured to return the sonar image presentation to the base display mode.

In some embodiments, the marine electronic device may be configured to present a focused display mode in which only a portion of the live sonar image is displayed. The focused display mode may correspond to a second volume of the underwater environment that is within and less than the first volume represented by the full live sonar image. The focused display mode may be generated using a subset of sonar return data or sonar image slices derived from the full sonar return data.

For example, FIG. 12A illustrates a full 360° live sonar image 424 formed using sonar return data from all available sonar beam slices, including those corresponding to ranges of angles 412, 384, 392, 410, 408, 390, 388, 406, 404, 386, 382, and 402. In contrast, FIG. 12B illustrates a partial live sonar image 424′ formed using only a subset of the sonar return data, specifically those corresponding to ranges of angles 402, 412, and 384. This subset represents a focused region of the underwater environment, and the corresponding sonar image is updated in substantially real-time using only the relevant sonar return beams.

Further, FIG. 12C illustrates a zoomed-in version of the partial live sonar image 424′′, wherein the display area is used to magnify the selected portion of the sonar image. In some embodiments, the focused display mode may be generated by cropping or re-rendering the sonar image data to fit a square or rectangular cross-section of the display, such that only sonar return data corresponding to the selected angular region is presented.

In some embodiments, the focused display mode may be dynamically updated based on user input or automated tracking. For example, FIG. 12D illustrates a partial live sonar image 424′′′ that has been rotated to track a target object 499. The marine electronic device may automatically adjust the subset of sonar beam slices used to generate the focused display mode such that the target object remains within the displayed region over time.

Similarly, FIG. 13A illustrates a full 180° live sonar image 724 formed using sonar return data from ranges of angles 521, 522, 531, 532, 541, and 542. In contrast, FIG. 13B shows a partial live sonar image 725 formed using only a subset of those ranges, specifically 521, 531, and 541, corresponding to a forward-focused view. FIG. 13C further illustrates a magnified version of the partial sonar image 726, and FIG. 13D shows a split 180° sonar image 727, wherein the fore and aft portions are visually separated to facilitate user interaction.

In some embodiments, the marine electronic device is configured to present a focused display mode by selectively rendering a portion of a previously generated live sonar image. Rather than regenerating the sonar image from raw sonar return data, the marine electronic device may crop, reframe, or magnify a subset of the full sonar image data to fit the display geometry and user-selected region of interest.

For example, the display may have a square or rectangular cross-section, and the focused display mode may be rendered by selecting sonar image slices corresponding to a directional region (e.g., forward, port-side, downward) and presenting only those slices within the bounds of the display. In this regard, the marine electronic device may take sonar image data from multiple angular ranges and render them within the selected display region, even if the selected slices are not contiguous or symmetrical.

In some embodiments, the focused display mode may be generated by applying a cropping operation to the full sonar image. For instance, the marine electronic device may identify a bounding box or angular sector defined by user input (e.g., touch gesture, voice command, preset selection) and render only the sonar image data within that region. This approach allows the marine electronic device to quickly present a focused view without reprocessing the underlying sonar return data.

In other embodiments, the marine electronic device may apply a magnification or zoom operation to the selected region of the sonar image. For example, the user may select a forward-focused region, and the marine electronic device may enlarge the corresponding sonar image slices to fill the display area. This technique may be used to enhance visibility of underwater features or targets within the selected region.

In some embodiments, the marine electronic device may dynamically update the focused display mode over time. For example, if a target object is selected or automatically identified, the marine electronic device may adjust the rendered region of the sonar image to ensure the target remains within view. This may involve shifting the angular coverage, rotating the displayed slices, or interpolating between adjacent sonar image data.

In some embodiments, the marine electronic device may be configured to generate a focused display mode by reprocessing a subset of the sonar return data corresponding to a selected region of the underwater environment. Rather than cropping or reframing a previously generated full sonar image, the marine electronic device may selectively filter and process only those sonar return beam slices that fall within the angular coverage of the focused display mode.

For example, upon receiving user input defining a focused region, such as a forward-facing sector, port-side slice, or zoomed-in area, the processor may identify the corresponding ranges of angles and select only the sonar return data associated with those ranges. The selected sonar return data may then be reprocessed to generate a new sonar image that represents the second volume of the underwater environment. This reprocessing may include beamforming operations, frequency bin filtering, and image construction steps tailored to the selected angular region. This approach may be advantageous in scenarios where the user desires enhanced resolution, reduced processing load, or real-time responsiveness for a specific region of interest. By limiting the processing to a subset of the sonar return data, the marine electronic device may reduce computational overhead and improve update rates for the focused display.

In some embodiments, the marine electronic device may combine reprocessing with display-layer rendering techniques. For example, the marine electronic device may reprocess sonar return data for a selected region and then apply magnification, cropping, or rotation operations to optimize the presentation of the focused sonar image on the display.

### Example System Architecture

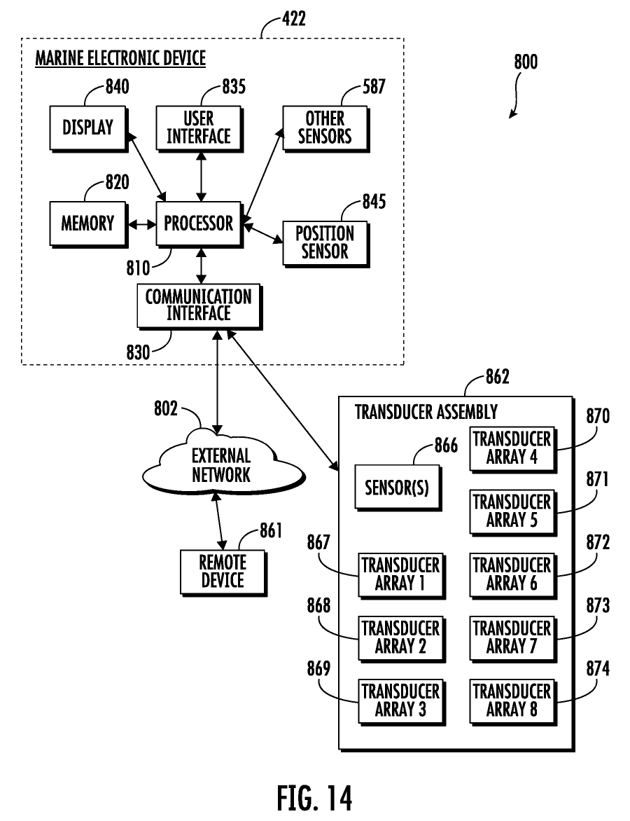

FIG. 14 shows a block diagram of an example sonar system 800 of various embodiments described herein. The illustrated sonar system 800 includes the marine electronic device 422 and a transducer assembly 862, although other systems and devices may be included in various example systems described herein. In this regard, the system 800 may include any number of different systems, modules, or components; each of which may comprise any device or means embodied in either hardware, software, or a combination of hardware and software configured to perform one or more corresponding functions described herein.

The marine electronic device 422 may include a processor 810, a memory 820, a user interface 835, a display 840, one or more sensors (e.g., position sensor 845, other sensors 847, etc.), and a communication interface 830. One or more of the components of the marine electronic device 422 may be located within a housing or could be separated into multiple different housings (e.g., be remotely located).

The processor 810 may be any means configured to execute various programmed operations or instructions stored in a memory device (e.g., memory 820) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 810 as described herein. In this regard, the processor 810 may be configured to analyze electrical signals communicated thereto to provide or receive sonar data, sensor data, location data, and/or additional environmental data. For example, the processor 810 may be configured to receive sonar return data, generate sonar image data, and generate one or more sonar images based on the sonar image data.

In some embodiments, the processor 810 may be further configured to implement sonar signal processing, such as in the form of a sonar signal processor (although in some embodiments, portions of the processor 810 or the sonar signal processor could be located within the transducer assembly 862). In some embodiments, the processor 510 may be configured to perform enhancement features to improve the display characteristics or data or images, collect or process additional data, such as time, temperature, GPS information, waypoint designations, or others, or may filter extraneous data to better analyze the collected data. It may further implement notices and alarms, such as those determined or adjusted by a user, to reflect depth, presence of fish, proximity of other vehicles, e.g., watercraft, etc.

In an example embodiment, the memory 820 may include one or more non-transitory storage or memory devices such as, for example, volatile and/or non-volatile memory that may be either fixed or removable. The memory 820 may be configured to store instructions, computer program code, marine data, such as sonar data, chart data, location/position data, and other data associated with the navigation system in a non-transitory computer readable medium for use, such as by the processor for enabling the marine electronic device 422 to carry out various functions in accordance with example embodiments of the present disclosure. For example, the memory 820 could be configured to buffer input data for processing by the processor 810. Additionally, or alternatively, the memory 820 could be configured to store instructions for execution by the processor 810.

The communication interface 830 may be configured to enable connection to external systems (e.g., an external network 802). In this manner, the marine electronic device 422 may retrieve stored data from a remote device 861 via the external network 802 in addition to or as an alternative to the onboard memory 820. Additionally or alternatively, the marine electronic device may transmit or receive data, such as sonar signals, sonar returns, sonar image data or the like to or from a transducer assembly 862. In some embodiments, the marine electronic device 422 may also be configured to communicate with other devices or systems (such as through the external network 802 or through other communication networks, such as described herein). For example, the marine electronic device 422 may communicate with a propulsion system of the watercraft (e.g., for autopilot control); a remote device (e.g., a user’s mobile device, a handheld remote, etc.); or other system.

The marine electronic device 422 may also include one or more communications modules configured to communicate with one another in any of a number of different manners including, for example, via a network. In this regard, the communications module may include any of a number of different communication backbones or frameworks including, for example, Ethernet, the NMEA 2000 framework, GPS, cellular, WiFi, or other suitable networks. The network may also support other data sources, including GPS, autopilot, engine data, compass, radar, etc. In this regard, numerous other peripheral devices (including other marine electronic devices or transducer assemblies) may be included in the system 800.

The position sensor 845 may be configured to determine the current position and/or location of the marine electronic device 422 (and/or the watercraft 100). For example, the position sensor 845 may comprise a global positioning system (GPS), bottom contour, inertial navigation system, such as machined electromagnetic sensor (MEMS), a ring laser gyroscope, or other location detection system.

The display 840, e.g., one or more screens, may be configured to present images and may include or otherwise be in communication with a user interface 835 configured to receive input from a user. The display 840 may be, for example, a conventional LCD (liquid crystal display), a touch screen display, mobile device, or any other suitable display known in the art upon which images may be displayed.

In some embodiments, the display 840 may present one or more sets of marine data (or images generated from the one or more sets of data). Such marine data includes chart data, radar data, weather data, location data, position data, orientation data, sonar data, or any other type of information relevant to the watercraft. In some embodiments, the display 840 may be configured to present such marine data simultaneously as one or more layers or in split-screen mode. In some embodiments, a user may select any of the possible combinations of the marine data for display.

In some further embodiments, various sets of data, referred to above, may be superimposed or overlaid onto one another. For example, a route may be applied to (or overlaid onto) a chart (e.g., a map or navigational chart). Additionally, or alternatively, depth information, weather information, radar information, sonar information, or any other navigation system inputs may be applied to one another.

The user interface 835 may include, for example, a keyboard, keypad, function keys, mouse, scrolling device, input/output ports, touch screen, or any other mechanism by which a user may interface with the system.

Although the display 840 of FIG. 14 is shown as being directly connected to the processor 810 and within the marine electronic device 422, the display 840 could alternatively be remote from the processor 810 and/or marine electronic device 422. Likewise, in some embodiments, the position sensor 845 and/or user interface 835 could be remote from the marine electronic device 422.

The marine electronic device 422 may include one or more other sensors 847 configured to measure or sense various other conditions. The other sensors 847 may include, for example, an air temperature sensor, a water temperature sensor, a current sensor, a light sensor, a wind sensor, a speed sensor, or the like.

The transducer assembly 862 illustrated in FIG. 11 includes eight transducer arrays 867, 868, 869, 870, 871, 872, 873, and 874. In some embodiments, more or less transducer arrays could be included, or other transducer elements could be included. As indicated herein, the transducer assembly 862 may also include a sonar signal processor or other processor (although not shown) configured to perform various sonar processing. In some embodiments, the processor (e.g., processor 810 in the marine electronic device 422, a processor (or processor portion) in the transducer assembly 862, or a remote processor – or combinations thereof) may be configured to filter sonar return data and/or selectively control transducer elements of the transducer arrays. For example, various processing devices (e.g., a multiplexer, a spectrum analyzer, A-to-D converter, etc.) may be utilized in controlling or filtering sonar return data and/or transmission of sonar signals from the arrays 867, 868, 869, 870, 871, 872, 873, and 874.

The transducer assembly 862 may also include one or more other systems, such as various sensor(s) 866. For example, the transducer assembly 862 may include an orientation sensor, such as gyroscope or other orientation sensor (e.g., accelerometer, MEMS, etc.) that can be configured to determine the relative orientation of the transducer assembly 862 and/or the various arrays 867, 868, 869, 870, 871, 872, 873, and 874 – such as with respect to a waterline, the top surface of the body of water, or other reference. In some embodiments, additionally or alternatively, other types of sensor(s) are contemplated, such as, for example, a water temperature sensor, a current sensor, a light sensor, a wind sensor, a speed sensor, or the like.

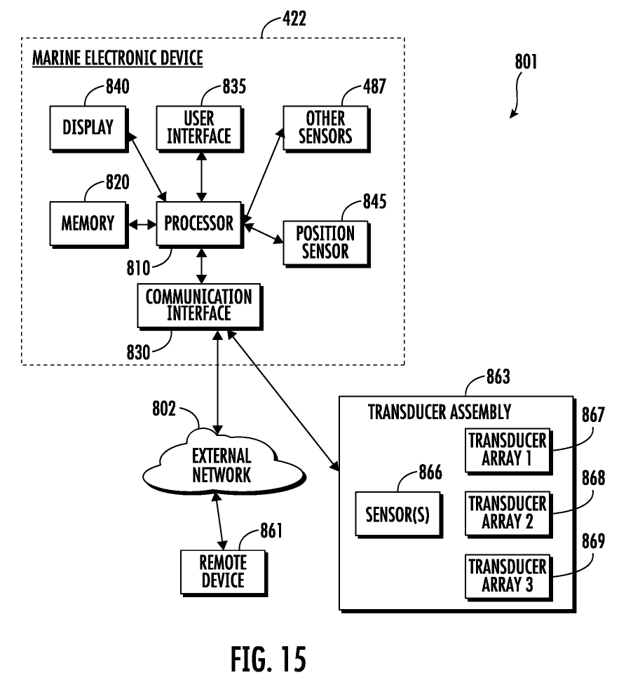

FIG. 15 shows a block diagram of another example sonar system 801 of various embodiments of the present invention described herein. The illustrated sonar system 801 includes the same various components and devices as the system 800 shown and described with respect to FIG. 14, but instead of eight transducer arrays, the system 801 includes three transducer arrays 867, 868, and 869 in a transducer assembly 863. Such an example transducer assembly 863 with three transducer arrays 867, 868, and 869 may correspond to various embodiments herein, such as some example embodiments shown and described with respect to FIGS. 8-11.

### Example User Input

In various embodiments, the marine electronic device may be configured to receive user input via one or more input modalities. The user input may be utilized to select a base display mode, define a focused display mode, identify a region of interest, initiate object tracking, or otherwise configure the presentation of sonar imagery. The following describes exemplary mechanisms by which user input may be captured.

In some embodiments, the marine electronic device includes a touchscreen display configured to receive direct user input via touch gestures. The user may interact with the sonar image by tapping a region of the image to select a focused sector, pinching or spreading to zoom in or out, swiping to rotate or pan the sonar image, or drawing a boundary or region using a finger or stylus to define a custom area of interest. Touchscreen input may also be used to activate interface elements such as buttons, sliders, or menus that correspond to display mode selection, zoom level, or tracking options.

In some embodiments, the user interface includes graphical user interface (GUI) elements configured to receive user input. The GUI elements may include dropdown menus, radio buttons, toggles, sliders, icons, overlays, or other selectable components. For example, the user may select a base display mode from a dropdown menu, toggle between focused display modes, adjust angular coverage using a slider, or select specific sonar beam slices via graphical overlays. The GUI elements may be presented on the marine electronic device or on a remote device communicatively coupled thereto.

In some embodiments, the marine electronic device may be configured to receive user input via preset configuration selection. The marine electronic device may offer predefined display configurations corresponding to common use cases, such as a scout mode for top-down 360° coverage, a forward mode for viewing ahead of the watercraft, a down mode for vertical imaging beneath the vessel, or a structure scan mode for focused imaging of underwater features. The user may select a preset via a menu, shortcut button, or other interface element, which automatically configures the sonar system to use predefined beam slices and display parameters.

In some embodiments, the marine electronic device may include a microphone and voice recognition system configured to receive voice commands. The user may issue spoken instructions to control the sonar display, such as “show forward view,” “zoom in on port side,” “track target,” or “switch to 360 mode.” Voice input may be processed locally or via a remote device, and may be used in conjunction with other input modalities.

In some embodiments, the marine electronic device may be communicatively coupled to a remote device, such as a smartphone, tablet, smartwatch, or handheld controller. The remote device may include a companion application or interface that mirrors or extends the sonar display controls. User input may be captured via touch gestures, physical buttons, joysticks, voice commands, or motion gestures (e.g., tilting or rotating the device to pan the sonar image). The remote device may communicate with the marine electronic device via wired or wireless protocols, including Bluetooth, Wi-Fi, or proprietary marine communication standards.

In some embodiments, the marine electronic device may include a camera or motion sensor configured to detect hand gestures or body movements. Gesture recognition may be used to capture user input, such as pointing to a region on the display to select a focused area, waving left or right to rotate the sonar image, or holding up fingers to indicate zoom level or angular coverage. Gesture recognition may be implemented using infrared sensors, depth cameras, or machine vision algorithms.

In some embodiments, the marine electronic device may be configured to automatically identify and track target objects (e.g., fish, underwater structures) based on sonar return data. The user may initiate tracking by selecting the object on the display, enabling a tracking mode via a GUI element, or issuing a voice command. Once tracking is enabled, the system may dynamically adjust the focused display mode to keep the target object within view one the display of the marine electronic device, updating the sonar image in real-time.

In some embodiments, the marine electronic device may include environmental sensors or position sensors configured to infer user intent or adjust display modes automatically. For example, the marine electronic device may detect watercraft orientation to switch between forward and down modes, use GPS or heading data to align sonar imagery with the watercraft’s direction, or adjust display based on trolling motor position or speed.

In some embodiments, the marine electronic device may be configured to store and recall custom input profiles. A custom input profile may specify preferred display modes, angular coverage, zoom levels, and interaction methods. The profile may be stored in memory and recalled via GUI selection, voice command, or remote device interaction.

The foregoing input modalities may be used individually or in combination, and may be implemented using hardware, software, or a combination thereof. The marine electronic device may be configured to prioritize certain input types, provide fallback mechanisms, or adaptively switch between input modalities based on context or user preference.

### Example Flowcharts and Operations

Embodiments of the present disclosure provide methods, apparatus and computer program products for operating a sonar system according to various embodiments described herein. Various examples of the operations performed in accordance with embodiments of the present disclosure will now be provided.

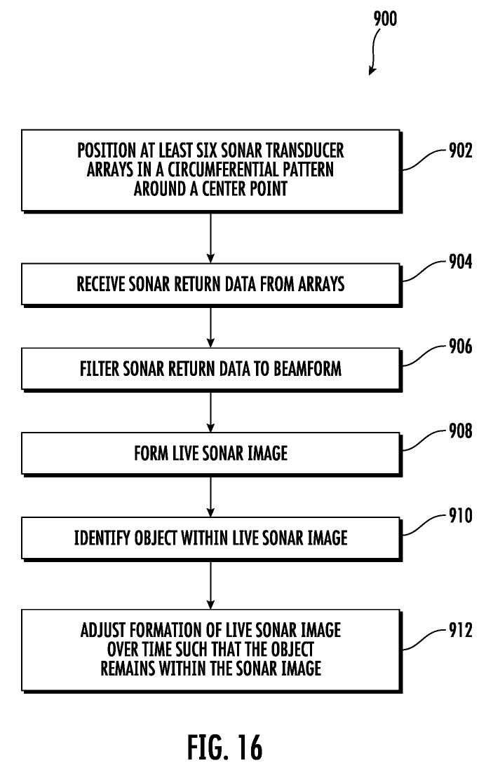

FIG. 16 illustrates a flowchart according to an example method 900 for operating a sonar system according to an example embodiment. The operations illustrated in and described with respect to FIG. 16 may, for example, be performed by, with the assistance of, and/or under the control of one or more of the processor 810, memory 820, communication interface 830, user interface 835, position sensor 845, other sensor 847, transducer assembly 862, 863, display 840, and/or external network 802/remote device 861. The method 900 may include positioning at least six sonar transducer arrays, such as in a circumferential pattern, around a center point at operation 902. For example, the at least six sonar transducer arrays may be positioned to lay in a same plane, or the at least six sonar transducer arrays may be positioned in a stacked configuration and lay in different planes, as discussed herein. At operation 904, the method comprises receiving sonar return data from the at least six sonar transducer arrays. Then, at operation 906, the sonar return data is filtered to beamform multiple sonar return beams. At operation 908, the method may include forming a live sonar image. For example, the live sonar image formed may be a 360° live sonar image, or the live sonar image may be a partial (e.g., less than 360°) live sonar image. The method may further include identifying an object within the live sonar image at operation 910. Finally, at operation 912, the method may include adjusting formation of the live sonar image over time such that the object remains within the live sonar image. In some embodiments, operations 910 and 912 may be optional. In some embodiments, the method may include additional, optional operations, and/or the operations described above may be modified, removed, or augmented, such as in accordance with various example embodiments described herein.

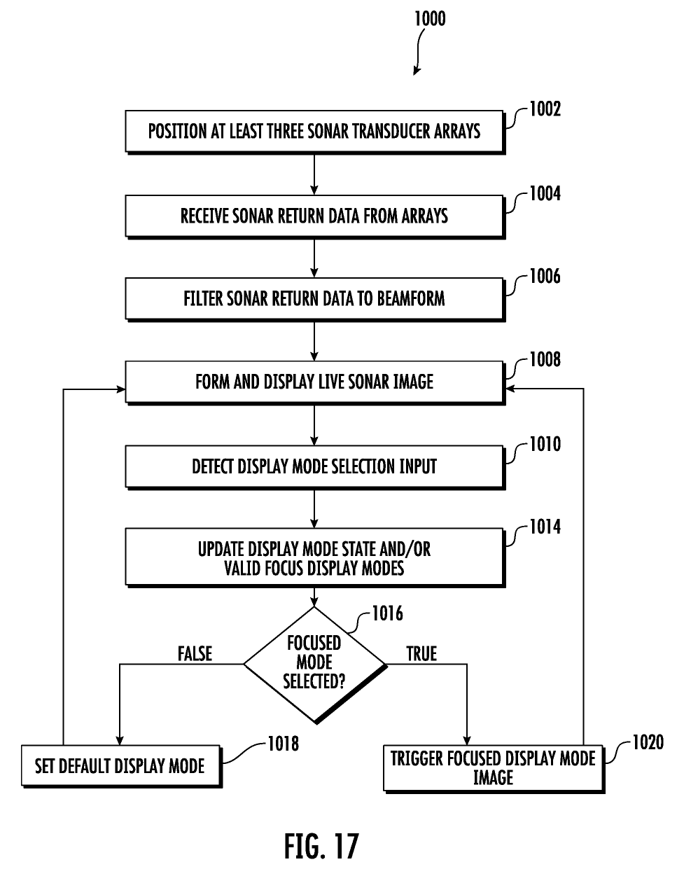

FIG. 17 illustrates a flowchart according to an example method 1000 for operating a sonar system according to an example embodiment. The operations illustrated in and described with respect to FIG. 17 may, for example, be performed by, with the assistance of, and/or under the control of one or more of the processor 810, memory 820, communication interface 830, user interface 835, position sensor 845, other sensor 847, transducer assembly 862, 863, display 840, and/or external network 802/remote device 861. The method 1000 may include positioning at least three sonar transducer arrays, such as in a circumferential pattern, around a center point at operation 1002. For example, the at least three sonar transducer arrays may be positioned to lay in a same plane, or the at least three sonar transducer arrays may be positioned in a stacked configuration and lay in different planes, as discussed herein. At operation 1004, the method comprises receiving sonar return data from the at least six sonar transducer arrays. Then, at operation 1006, the sonar return data is filtered to beamform multiple sonar return beams. At operation 1008, the method may include forming and displaying a live sonar image. For example, the live sonar image formed may be a 180° live sonar image, or the live sonar image may be a partial (e.g., less than 180°) live sonar image.

At operation 1010 a user interaction is detected with user interface 835 corresponding to a display mode selector. The display mode selector enables the user to choose among multiple perspective modes for sonar visualization. The display mode selector may allow the user to choose a default of base display mode such as a first perspective mode, exemplary depicted in FIG. 12A, which provides a top-down sonar visualization, and a second perspective mode, exemplary depicted in FIG. 13A, which provides a side-perspective sonar visualization. The display mode selector may further allow the user to choose one or more focused display modes, according to the embodiments herein.

At operation 1010, one or more identifiers corresponding to the selected display mode are determined. The identifier may correspond to the default of base display mode and/or the focused display mode(s). At operation 1014, an internal state variable is set to reflect the selected display mode. This state variable governs subsequent rendering operations and that which is rendered by user interface 835 upon display 840.Further at operation 1014 valid focus display modes are determined based upon the internal state variable. For example, when the first perspective base mode is selected, valid focused modes may include a full 360° coverage, a forward 180° coverage, and one or more focused sectors. Focused sectors may include fore-to-aft subdivisions such as bow-starboard, bow, bow-port, stern-starboard, stern, stern-port, etc. When the second perspective mode is selected, valid focused modes may include equal lateral coverage, forward-focused coverage, down-focused coverage, etc. Further at operation 1014, user interface 835 may be updated to present selectable options corresponding to the valid focused modes. This may include displaying, enabling, or disabling specific GUI elements, updating labels, or the like.

At operation 1016, the system determines whether a focused mode was preselected, currently selected, retained from a prior session, or retained as a user-default setting. If a focused mode is preselected and valid for the current display mode, method 1000 proceeds to operation 1014, where the marine electronic device triggers a rendering update based on the selected display mode and focused mode. If no valid preselection exists, the method proceeds to operation 1018, where the marine electronic device assigns the current display mode as the selected default or base display mode. Alternatively, at operation 1020, the live sonar image is updated according to the selected display mode and focused mode. The rendering update may include a change to the overall base display mode and/or an adjustment to angular coverage, zoom level, and spatial orientation to reflect the selected configuration. The method 1000 then returns to a monitoring state for subsequent user interactions.

FIG. 16 and FIG. 17 illustrates a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 520 and executed by, for example, the processor 510. As will be appreciated, any such computer program product may be loaded onto a computer or other programmable apparatus (for example, a marine electronic device 422) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 422) to cause a series of operations to be performed on the computer or other programmable apparatus to produce a computer-implemented process such that the instructions which execute on the computer or other programmable apparatus implement the functions specified in the flowchart block(s).

### Conclusion

Many modifications and other embodiments of the disclosure set forth herein may come to mind to one skilled in the art to which the disclosure pertains having the benefit of the teachings presented in the foregoing descriptions and the associated drawings. Therefore, it is to be understood that the embodiments of the disclosure are not to be limited to the specific embodiments disclosed and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

WHAT IS CLAIMED IS:

1. A marine electronic device of a watercraft, the marine electronic device being configured to present sonar imagery, the marine electronic device comprising:
a display;
a processor;
a memory;
a communication interface configured to receive sonar return data from a sonar transducer assembly comprising a plurality of sonar transducer arrays;
wherein the processor is configured to:
receive first sonar return data from the sonar transducer assembly, wherein the first sonar return data corresponds to a first volume of an underwater environment;
generate and present a live sonar image based on the first sonar return data, wherein the live sonar image provides a representation of the first volume of the underwater environment, wherein an entire portion of the live sonar image corresponding to the first volume is continually updated in real-time;
receive an indication of user input defining a portion of the live sonar image, wherein the portion of the live sonar image corresponds to a second volume of the underwater environment that is within the first volume and less than the first volume; and
generate and present, based on the portion of the live sonar image, a second live sonar image based on second sonar return data corresponding to the second volume of the underwater environment, wherein the second sonar return data is a subset of data within the first sonar return data and is less than the first sonar return data.

2. The marine electronic device of claim 1, wherein the indication of user input comprises a touch gesture received via a touchscreen of the display, the touch gesture defines the portion of the live sonar image to be presented in the second live sonar image.

3. The marine electronic device of claim 1, wherein the indication of user input comprises a voice command received via a microphone, the voice command specifying a directional region of the underwater environment to be displayed in the second live sonar image.

4. The marine electronic device of claim 1, wherein the indication of user input comprises a selection of a target object within the live sonar image, and wherein the processor is configured to dynamically update the second live sonar image over time such that the target object remains within the displayed portion of the underwater environment.

5. The marine electronic device of claim 1, wherein the indication of user input comprises a selection of a predefined display mode, the predefined display mode corresponds to one of a forward-focused sector, a downward-focused sector, a port-side-focused sector, or a starboard-side-focused sector of the underwater environment.

6. The marine electronic device of claim 1, wherein the indication of user input comprises a selection made via a remote device communicatively coupled to the marine electronic device, the remote device configured to transmit display mode instructions based on user interaction with a companion interface of the remote device.

7. The marine electronic device of claim 1, wherein the processor is further configured to present a first selectable interface element on the display, the first selectable interface element configured to allow a user to select a base display mode from among a plurality of base display modes.

8. The marine electronic device of claim 7, wherein the processor is further configured to present a second selectable interface element on the display, the second selectable interface element configured to allow the user to select a focused display mode amongst a plurality of predetermined focused display modes associated with the selected base display mode.

9. The marine electronic device of claim 8, wherein the processor is further configured to present a third selectable interface element on the user interface, the third selectable interface element configured to allow the user to return to the selected base display mode from a selected focused display mode.

10. The marine electronic device of claim 8, wherein the focused display modes include at least one of: a zoomed-in sector view, a port-side sector view, a starboard-side sector view, a forward-focused view, or a tracked-object view.

11. The marine electronic device of claim 1, wherein the second live sonar image is generated by reframing the live sonar image, such that only sonar image data corresponding to the portion of the live sonar image is presented.

12. The marine electronic device of claim 1, wherein the second live sonar image is generated by processing the subset of the data within the first sonar return data corresponding to the portion of the live sonar image.

13. The marine electronic device of claim 1, wherein the first live sonar image is a 360° image extending around and below the watercraft.

14. The marine electronic device of claim 1, wherein the first live sonar image is a 180° image extending below the watercraft in a fore-to-aft perspective.

15. The marine electronic device of claim 1, wherein the first live sonar image is a 180° image extending below the watercraft in a port-to-starboard perspective.

16. A marine system for a watercraft, the marine system comprising:
a sonar transducer assembly comprising a plurality of sonar transducer arrays,
wherein each sonar transducer array comprises a plurality of transducer elements configured to operate at a fixed phase shift and vary in frequency so as to beamform multiple sonar return beams for receiving sonar return data from an underwater environment relative to the watercraft;
a marine electronic device comprising:
a display;
a processor;
a memory; and
a communication interface configured to receive sonar return data from the sonar transducer assembly;
wherein the processor is configured to:
receive first sonar return data from the sonar transducer assembly, wherein the first sonar return data corresponds to a first volume of the underwater environment;
generate and present a live sonar image based on the first sonar return data, wherein the live sonar image provides a representation of the first volume of the underwater environment, wherein an entire portion of the live sonar image corresponding to the first volume is continually updated in real-time;
receive an indication of user input defining a portion of the live sonar image, wherein the portion of the live sonar image corresponds to a second volume of the underwater environment that is within the first volume and less than the first volume; and
generate and present, based on the portion of the live sonar image, a second live sonar image based on second sonar return data corresponding to the second volume of the underwater environment, wherein the second sonar return data is a subset of data within the first sonar return data and is less than the first sonar return data.

17. The marine system of claim 16, wherein the indication of user input comprises a touch gesture received via a touchscreen display, the touch gesture defining the portion of the live sonar image to be presented in the second live sonar image.

18. The marine system of claim 16, wherein the indication of user input comprises a selection of a predefined display mode, the predefined display mode corresponding to a forward-focused sector, a downward-focused sector, a port-side-focused sector, or a starboard-side-focused sector of the underwater environment.

19. The marine system of claim 16, wherein the indication of user input comprises a selection made via a remote device communicatively coupled to the marine electronic device, the remote device configured to transmit display mode instructions based on user interaction with a companion interface of the remote device.

20. A method for presenting sonar imagery on a display of a marine system of a watercraft, the method comprising:
receiving first sonar return data from a sonar transducer assembly comprising a plurality of sonar transducer arrays, wherein each sonar transducer array comprises a plurality of transducer elements configured to operate at a fixed phase shift and vary in frequency to beamform multiple sonar return beams;
generating and presenting a live sonar image based on the first sonar return data, wherein the live sonar image provides a representation of a first volume of an underwater environment, and wherein an entire portion of the live sonar image corresponding to the first volume is continually updated in real-time;
receiving an indication of user input defining a portion of the live sonar image, wherein the portion corresponds to a second volume of the underwater environment that is within the first volume and less than the first volume; and
generating and presenting a second live sonar image based on second sonar return data corresponding to the second volume of the underwater environment, wherein the second sonar return data is a subset of the first sonar return data and is less than the first sonar return data.
